(19) United States
(12) Patent Application Publication
(10) Pub. No.: US 2003/0176602 A1
(43) Pub. Date: Sep. 18, 2003

(54) Temperature-controlled process for preparation of homogeneous polymers

(76) Inventors: Richard Schmidt, Vedbaek (DK); Robert Lessel, Brondby (DK); Jens-Erik Sorensen, Hellerup (DK)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/227,265

(22) Filed: Aug. 26, 2002

Related U.S. Application Data
(60) Provisional application No. 60/314,672, filed on Aug. 27, 2001.

(30) Foreign Application Priority Data
Aug. 25, 2001 (DK) PA 2001 01266

(51) Int. Cl. C08G 77/00; C08G 18/00; C08G 63/02; C08F 2/00

(52) U.S. Cl. 526/64; 528/44; 528/272; 528/170; 528/10; 526/319; 526/264

(57) ABSTRACT

A process which allows for the preparation of a substantially uniform hydrogel, such as a polyacrylamide hydrogel, wherein the uniformity of the hydrogel, in terms of the rheological properties, is established by limiting the temperature differential in the reaction process to a very narrow range, such as no more than 5° C. This process allows for polymers novel in their uniformity also by means of being suitably a continuous process. A continuous process for the preparation of a substantially uniform hydrogel, such as a polyacrylamide hydrogel, led to high uniformity by preventing unreacted monomers, such as acrylamide, from surpassing the gel front in the pipe reactor. This was achieved by use of a static mixer. Polymer hydrogels are rendered biocompatible by means of a novel washing process wherein the polymer specific surface area is appropriately set.

### FIELD OF THE INVENTION

The present invention relates to an inline process for the preparation of hydrogels wherein the temperature of the cross-linking process is regulated thus allowing for a homogeneous product for inter-batch and intra-batch.

### GENERAL BACKGROUND

Product homogeneity is of critical importance in the manufacture of products in general, but critically problematic to achieve in the field of polymer chemistry on an industrial scale.

The process of U.S. Pat. No. 5,306,404 is directed to the preparation of polyacrylamide gel plates for gel electrophoresis with good reproducibility and at a plurality of gel concentrations. The process of U.S. Pat. No. 5,306,404 prepares gels by combining specific and selected concentrations of the monomer, the peroxide solution, and the reducing solution such that the gel is suitable for electrophoresis. The gels prepared by said method do not control for intra-batch temperature variations. The gel is furthermore not biocompatible.

The process disclosed by WO 96/04943 for the synthesis of polyacrylamides involves many steps and, by its nature, results in a relatively broad gel specification range with variation contributions from all the processing levels. Even for the skilled polymer chemist, the carefully executed procedures of WO 96/04943 results in a hydrogel with inhomogeneous product characteristics (see Example 1).

Conventional methods for the preparation of hydrogels are typified by WO 96/04943, wherein the process involves many manually operated steps, namely, preparation of the individual mixtures, mixing appropriately measured samples of the two mixtures for the desired batch, at a set temperature, degassing with an inert gas, casting of the reaction mixture into several beakers (depending on the “batch” size); polymerisation in the beakers for at least ½-1½ hr.; demolding of the cylinder shaped gel; extraction of residuals and equilibration in water for 92 hrs. (requiring eight shifts of water); homogenisation of the purified gels by grinding with an up and downwards moving grid; filling of the a storage/packing container with the homogenised gel material; finally autoclavation of the storage/packing containers.

In performing conventional methods, such as those described by WO 96/04943, the present investigators assessed that the total time for production is almost one week of work including eight shifts of water for the extraction process. The investigators have found that a production of a 10 litre gel consists of five initiation operations and 100 molding and demolding operations. This invariably results in a relatively broad gel specification range with variation contributions from all the processing levels.

For a person skilled in the art of polymer chemistry/production, it can be rationalised that even when the procedures are carried out correctly, the inherent possibility for obtaining inhomogeneous product characteristics—especially in the casting and polymerisation step is great and is wasteful of resources.

U.S. Pat. No. 4,535,131 relates to a process for producing partially hydrolyzed acrylamide polymers using alkali agents at a temperature in the range of 50 to 95° C. The intra-batch temperature variations of the polymerization process were not controlled.

Mengun Cao (CN1999099116009) discloses the preparation of polyacrylamide hydrogels with different cross-linking density and concentration.

WO 01/42312 relates to a method for preparing polymers by controlled free-radical polymerization with xanthates. The intra-batch temperature variations of the polymerization process were not controlled.

WO 00/31148 relates to the synthesis of polyacrylamide hydrogels and hydrogel arrays made from polyacrylamide reactive pre-polymers. The intra-batch temperature variations of the polymerization process were not controlled.

U.S. Pat. No. 6,277,948 relates to a method for the synthesis of polyamides. The intra-batch temperature variations of the polymerization process were not controlled.

### SUMMARY OF THE INVENTION

In their ongoing research in the area of polymer synthesis, the present investigators have found that polymer inhomogeneity is due in great part to intra-batch temperature variations during the polymerisation process. Temperature variations affect the length of chains, the degree of cross-linking and rheological properties, to mention but a few. The present investigators have developed a process which can be run continuously or batch-wise, wherein the temperature variations within the reaction mixtures and controlled. The present investigators have surprisingly found that the polymer products of this process to have high homogeneity and high quality. The continuous process of the invention allows for the preparation of large quantities of polymers with high inter- and intra-batch homogeneity and for the preparation of a variety of types of polymers, with varying and controllable molecular weights and rheological properties.

A first object of the invention relates to a method of providing a polymer hydrogel with high homogeneity by means of providing a reaction set up appropriate for the reaction conditions. This first object is thus directed to a process for the preparation of a substantially uniform polymer hydrogel comprising a polymerisation reaction comprising the steps of:

(i) combining a monomer component, a cross-linking component, an initiator, and optionally a promoter, or inert premixtures thereof, in a mixer;

said combining resulting in a polymerization-initiated mixture;

ii) providing said polymerization-initiated mixture through a pipe reactor such that the mixture flows in a net longitudinal direction; said providing resulting in polymer formation; wherein polymerisation reaction is a condensation or radical polymerisation;

said process comprising limiting a temperature differential between any two positions within the reactor to no more than 9° C.

The first object of the invention can be alternatively defined as relating to a method for controlling the temperature differential between any two positions within a reactor in a process for the preparation of a polymer hydrogel comprising a polymerisation reaction comprising the steps of:

(i) combining a monomer component, a cross-linking component, an initiator, and optionally a promoter, or inert premixtures thereof, in a mixer;

said combining resulting in a polymerization-initiated mixture;

ii) providing said polymerization-initiated mixture through a pipe reactor such that the mixture flows in a net longitudinal direction; said providing resulting in polymer formation; wherein polymerisation reaction is a condensation or radical polymerisation; wherein said pipe reactor having a construction selected from the group consisting of

a) the pipe reactor having a diameter of no more than 25 mm at a monomer concentration of 2 to 5% (wt/wt) and a polymer-formation temperature of 5 to 65° C.;

b) the pipe reactor having a diameter of no more than 15 mm at a monomer concentration of 6.1 to 10% (wt/wt) and a polymer-formation temperature of 5 to 65° C.;

c) the pipe reactor having a diameter 10 mm at a monomer concentration of 10.1 to 22% (wt/wt) and a polymer-formation temperature of 5 to 65° C.

A second object of the invention relates to a method of providing a polymer hydrogel produced in a continuous process with high homogeneity by ensuring that unreacted liquid monomer does not overtake the gel front. This second object relates to a process for the preparation of a substantially uniform polymer hydrogel in a continuous process comprising a polymerisation reaction said reaction comprising the steps of

(i) combining a monomer component, a cross-linking component, and an initiator, or inert premixtures thereof;

ii) mixing the monomer component, cross-linking component, and optionally the initiator or promoter, or inert premixtures thereof until the resulting polymerization-initiated mixture is a premature gel with an elasticity module G′ of 0.75 to 2.5 Pa;

iii) providing said polymerization-initiated mixture through a pipe reactor such that the mixture flows in a net longitudinal direction; said providing resulting in the substantially uniform polymer hydrogel.

A third object of the invention relates to providing a polymer hydrogel which is biocompatible in that the often toxic monomers are removed from the final gel by a washing process. Convention washing processes, in order to effectively remove residual toxins, are time consuming and thus result in hydrogels which are very swollen, having a low solid weight content, and thus often not to the specification required for the intended prosthetic purpose. The washing process of the invention effectively removes residual toxins at a controllable rate to achieve the desired solid weight content and thus the desired rheological properties. The third object of the invention is directed to a method of removing monomeric units from a polymer hydrogel comprising providing the polymer hydrogel so as to have a specific surface area of at least 1.5 cm²/g; washing the polymer hydrogel such that the level of monomeric unit in the hydrogel is less than 400 ppm with an aqueous medium. Alternatively stated, the third object of the invention relates to a method of swelling a polymer hydrogel comprising providing the polymer hydrogel so as to have a specific surface area of at least 1.5 cm²/g; contacting the polymer hydrogel with an aqueous medium until the desired solid-weight content is obtained.

An important object of the invention relates to the novel uniform polymer hydrogel obtainable by the methods and processes of the invention, namely to a substantially uniform polyacrylamide hydrogel obtainable according to a process defined in any one of claims 1-49, or 82-135 or by a method defined in any one of claims 50-81.

A further object of the invention relates to a process for the preparation of a polyacrylamide hydrogel comprising

i) combining an acrylamide component, methylene bis-acrylamide component, and a radical initiator component, or inert premixture components thereof;

ii) mixing the acrylamide component, methylene bis-acrylamide component, and the radical initiator component, or inert premixture components thereof until the formation of the polyacrylamide hydrogel;

iii) contacting a the polyacrylamide hydrogel with a solvent which is miscible with water and which is soluble to the acrylamide component or methylene bis-acrylamide and which is not a solvent for the polymer, said solvent provided in excess so as to extract the water from the hydrogel as well as the acrylamide component or methylene bis-acrylamide until a white solid polymer is precipitated as well as to a polyacrylamide hydrogel obtained by a process defined in any one of claims 141 to 148.

### DESCRIPTION OF THE INVENTION

The process of the invention addresses these real-life problems and solves the problems of product lack of product homogeneity in hydrogels by developing a process which allows for versatile control of the each of the reaction conditions which affect the product quality.

The process of the invention is applicable to the synthesis of polymeric hydrogels wherein the polymerisation reaction is an exothermic reaction. Such exothermic polymerisation reactions encounter problems of product homogeneity such as in connection to narrow molecular weight distribution, regularity of network, cross-linking density and rheological features. Suitable exothermic polymerisation reactions are condensation and radical polymerisation reactions in either solid or solution mass.

As stated, a first object of the invention relates to a method of providing a polymer hydrogel with high homogeneity by means of providing a reaction set up appropriate for the reaction conditions. This first object is thus directed to a process for the preparation of a substantially uniform polymer hydrogel comprising a polymerisation reaction comprising the steps of:

(i) combining a monomer component, a cross-linking component, an initiator, and optionally a promoter, or inert premixtures thereof, in a mixer;

said combining resulting in a polymerization-initiated mixture;

ii) providing said polymerization-initiated mixture through a pipe reactor such that the mixture flows in a net longitudinal direction; said providing resulting in polymer formation; wherein polymerisation reaction is a condensation or radical polymerisation;

said process comprising limiting a temperature differential between any two positions within the reactor to no more than 9° C.

The conventional process (such as the process described by WO 96/04943) typically involves the manual preparation of the bulk units of acrylic amide, cross-linker and initiator or co-initiator solutions. Polymerization is initiated by mixing and initiating the reagents followed by immediate casting into mould beakers. This meant that a production of approximately 10 litres of gel required several separate initiation operations and many more moulding operations. By nature, this results in a relatively broad gel specification range with varying contributions from all operational steps and processes. In addition, it is well known that PAAG polymerization yields relatively non-homogeneous structures of cross-linking bonds unevenly distributed.

As can be seen from Example 1, conventional methods do not allow for satisfactory product homogeneity due to a large temperature differential between the temperature at the centre and the perimeters of the container wherein the polymerisation is taking place. This is due, at least in part to the exotherm being highest at the centre and heat dispersion being least effective at the centre. As can be seen from Table 1, the temperature differential between two positions within the gel medium can be as high as 9.2° C., at a single moment within the polymerisation process. Moreover, by the conventional process, throughout the reaction process, the reaction temperature vary dramatically, such as by 10.9° C. on the side of the beaker from 400 s to 1900 s.

The problem was not solved by preheating the solutions prior to mixing, performing the mixing or the polymerisation at a higher temperature, as similar temperature variations were observed under those conditions. When the conventional process is performed in a water bath at 45° C., the reaction temperature quickly reaches temperatures up to 56° C. Under such conditions, the hydrogel does not form a polymer network but rather a viscous liquid with a very low G′-modulus. This is due, at least in part, to the formation of a great number of significantly smaller single chains which do not cross-link.

At higher temperature the chain length of the individual polymer molecules formed are shorter resulting in a lower amount per molecule-chain of crosslinker and therefore also in an overall lower density of crosslinks per volume gel. This gives rise to the lower modulus/viscosity and if the temperature is high enough (>60° C.) to the possibility of formation of larger amounts of non-crosslinked materials (leachables).

As shown in Table 2, the temperature at which polymerisation is taking place greatly affects the elasticity modulus (G′ modulus) and viscosity of the polymer hydrogel. For instance, a temperature differential of only 5° C. from 45° C. to 40° C. increases the G′ modulus by 66%; a temperature differential of only 5° C. from 50° C. to 45° C. increases the G′ modulus by over 110%.

The present investigators thus provide for a process for a homogenous polymer and for the controllable adaptation of the rheological characteristics of the hydrogel. The control of the product homogeneity is obtained by controlling the reaction temperature such that temperature variation is minimised throughout the reaction medium. The present investigators have successfully minimised the temperature variation within the polymerisation reaction medium such that said temperature variation is less than about 9° C., typically and more preferably less than about 5° C.

A primary aspect of the invention relates to a process for the preparation of a hydrogel having desired rheological characteristics. These characteristics are attributable, at least in part, to the process by which the hydrogel is prepared. The invention thus further relates to a process for the manufacture of the hydrogel. The process of the invention is such that not only to achieve the desired rheological characteristics but to achieve said characteristics in controllable manner such so as to allow controllable variations in the rheological characteristics of the hydrogel. The invention provides for a hydrogel such that the features of the hydrogel are homogenous throughout the hydrogel (intra-unit homogeneity) and homogenous between production processes (inter-unit homogeneity). It has been demonstrated that by the present investigators that current processes produce highly inhomogeneous hydrogels, both resulting, at least in part, by temperature inhomogeneity in the gel during the casting process. Furthermore, the present investigators have demonstrated that the rheological characteristics of the hydrogel such as the G′-modulus (elasticity) are very sensitive to variations in the polymerisation temperature.

The processes of the invention with the inline cross-linking technology (ILX) has major advantages over conventional processes for the production of polyacrylamide hydrogels:

ILX is, in a preferred embodiment, a continuous process thus little or no sub-batch level variations;

polymerization conditions can be controlled in the pipe reactor to yield more homogenous gels (i.e. the process complies with requirements of validation and narrow gel specifications in terms of elasticity, viscosity and solid weight content);

ILX is a compact process line allowing automation and minimised exposure of hazardous monomers to the operator;

ILX is easily adjustable in batch size and the processing conditions can be pre-set to produce gels with varying degrees of cross-linking, elasticity, viscosity and/or solid content.

The present investigators have remarkably been able to repeatedly and consistently perform the process of the invention such that the temperature differential between any two positions within the reactor is as low as 1.3-2.6° C. As was determined by the present investigators, the temperature difference between the wall (=the temp in the water bath) and the centre part of the tube has been narrowed to about 1.3-2.6° C. This surprising results is a dramatic improvement compared to conventional method comprising a casting process in beakers and of great importance for providing products with satisfactory homogeneity.

The present invention thus provides for a process for a homogenous polymer or hydrogel and for the controllable adaptation of the rheological characteristics of the polymeric hydrogel. The method of the invention and advantages of the method are exemplified by the process as adapted for the preparation of polyacrylamide hydrogels. The process for the preparation of polyacrylamide hydrogels is one preferred embodiment of the process and advantages of the process performed for the preparation of polyacrylamide are easily ascribable to the process for the preparation of an array of polymers.

As stated, an important feature for the preparation of substantially uniform polymer hydrogel comprises limiting a temperature differential between any two positions within the reactor to no more than 9° C. Typically, according to this object of the invention, the temperature differential is of no more than 8° C. between any two positions within the reactor, such as no more than 7° C., 6° C., preferably no more than 5° C., even more preferably not more than 4° C., most preferably not more than 3° C.

The processes and methods of the invention are flexible in that they can be performed as a batch process or a continuous process. Preferably, the processes and method s of the invention are performed in a continuous manner, particularly those processes of the invention related to addressing the problem of preventing unreacted monomer from surpassing the gel front during the polymerisation process.

The substantial uniformity of the polymer hydrogel is intended to mean that the polymer hydrogel is substantially uniform such that the elasticity modulus from at least two positions of the gel differ by no more than 200%, such as no more than 180%, such as no more than 170%, no more than 165%, no more than 160%, no more than 155%, no more than 150%, no more than 145%, no more than 140%, no more than 135%, no more than 130%, no more than 125%, no more than 120%, no more than 115%, no more than 110%, no more than 105%, no more than 100%, no more than 95%, no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, such as no more than 10%.

Otherwise stated, wherein the polymer hydrogel is substantially uniform such that the elasticity modulus from at least two positions of the gel differ by no more than 100 Pa, such as no more than 95 Pa, such as no more than 90 Pa, no more than 85 Pa, no more than 80 Pa, no more than 75 Pa, no more than 70 Pa, no more than 80 Pa, no more than 75 Pa, no more than 70 Pa, no more than 65 Pa, no more than 60 Pa, no more than 55 Pa, no more than 50 Pa, no more than 45 Pa, no more than 40 Pa, no more than 35 Pa, no more than 30 Pa, no more than 25 Pa, no more than 20 Pa, no more than 15 Pa, such as no more than 10 Pa.

The term “pipe reactor” is intended to mean a tubular, rectangular or other angular conduit wherein a preponderance of the ploymerization takes place. The pipe reactor is preferably tubular. The pipe reactor may be fitted so as to be cooled or heated. The pipe reactor may be coaxial in arrangement so as to allow temperature transfer from the inner walls and the outer walls of the conduit comprising the reaction mixture.

Typically, the method and processes of the invention are performed in a continuous manner. Within such an embodiment, at least one of the mixing or providing steps is performed under gradient pressure. The person skilled in the art would understand the invention to further relate to automated processes and methods.

Typically, the processes and methods of the invention comprise polymerisation reactions which is a condensation or radical polymerisation.

The combining step comprises combining a monomer component, a cross-linking component, an initiator, and optionally a promoter, or inert premixtures thereof, in a mixer; said combining resulting in a polymerization-initiated mixture.

Suitable polymers made from the polymerisation reactions of the present invention may be selected from the group comprising polyacrylamides, polyesters, polyethers, polyolefins, silicones, polyketones, aramides, polyimides, rayon, polyvinylpyrrolidone, polyacrylates, and polyurethanes, such as polyurethane methacrylates. The polymer may any prepared by condensation reactions or radical polymerisation.

Typical polymer systems may be based on the group comprising hydroxyethyl methacrylate, hydroxyethoxyethyl methacrylate, hydroxydiethoxyethyl methacrylate, methoxyethyl methacrylate, methoxyethoxyethyl methacrylate, methoxydiethoxyethyl methacrylate, ethylene glycol dimethacrylate, polyethylene glycol methacrylate, N-vinyl-2-pyrrolidone, methyacrylic acid, acrylate, methacrylate, acrylamide and methacrylamide, vinyl alcohols, vinyl acetates, which can be optionally hydrolysed, an salts thereof. The monomer may be any known to participate in condensation polymerisation reactions or radical polymerisation reactions for the production of hydrogels. The can be any array of groups with reactive side groups or end groups.

Cross-linking agents are known to the person skilled in the art for preparing hydrogels (see Hydrogels in Medicine and Pharmacy, N. A Peppas, 1986, CRC Press). These include groups of an array of chain lengths having a hyroxyl group, a terminal olefin, a vinyl group, a vinyl ether, carboxylic acids, carboxylates, carboxylic esters, amine, amides, acid halides. Radical polymerisation reaction suitably use olefins, vinyl groups, vinyl ethers and alkynes as cross-linking agents. Suitable examples include methylene-bis-acrylamide and ethyleneglycol dimethyacrylate derivatives. Cross-linking agents may be uni-functionalised as well wherein on moiety of the agent is chemically reactive to form a covalent bond with one chain of the polymer and another moiety is capable of hydrogen bonding to another chain of the polymer.

In redox radical reactions, an array of redox agents may be used such as TEMED, sodium metabisulfite and ferrous salts. Chemical initiation may be via thermal energy, ultraviolet light, visible light, and peroxides such as ammonium persulfate and hydrogen peroxide.

In a suitable embodiment of the present invention, the monomer component, cross-linking component, initiator, and optionally the promoter, or inert premixtures thereof, may be pre-heated prior to the combining step or prior to the providing step. Thus, the process of the invention may comprise a pre-heating step. This pre-heating step minimises the delay in the start of the polymerisation which occurs in polymerisation reaction wherein the components are not pre-heated prior to the providing step. This delay is due to the fact that the combined mixtures are at room temperature when loaded into the tube and are heated to the polymerisation temperature.

The pre-heating step comprises heating the monomer component, cross-linking component, initiator, and optionally the promoter, or inert premixtures thereof, to a temperature selected from the group consisting of 40° C. to 65° C., such as 40° C., 45° C., 50° C., 55° C., 60° C., and 65° C.

The pre-heating step affects the exotherm observed in the tube reactor. The temperature differential in embodiments comprising a pre-heating step is typically slightly higher compared to the experiments where the component solutions were at room temperature at the combining and/or providing step. In embodiments comprising a pre-heating step the temperature differential is typically approximately no more than 6.5° C., such as no more than 6° C., preferably no more than 5° C.

In a suitable embodiment, the temperature differential between any two points within the mixer is no more than 9° C., such as no more than 8° C., 7° C., 6° C., 5° C., 4° C., or 3° C.

The presence of oxygen in the during the combining, mixing or providing step is undesirable as oxygen functions, in general, as an inhibitor of radical polymerization reactions and affects the start time of the gelatinization reaction.

The combining or mixing may lead to gelatinization which is intended to mean approximately 10-30% polymerization.

In the processes of the invention, it is possible to conduct each of the operations, e.g. combining and mixing of the components, providing the reaction medium for polymerization in the tube reactor, in a closed system with the possibility of controlling all the important parameters such as the temperature and oxygen level, which may affect the final properties of the polyacrylamide gel.

The monomer components may be pre-mixed to form inert pre-mixtures. The monomer components or inert pre-mixtures may be degassed with an inert gas so as to lower the oxygen content in the respective solutions.

The components are combined, optionally under a pressure gradient, such as by means of a pump and passed through a mixer. As is known to the person skilled in the art, a static or mechanical mixer may be used for mixing. In a preferred embodiment, for convenience of operation purposes, the components are passed through a static mixer. The diameter and the step of a static mixture may be adjusted. The mixer mixes the combined components.

The static mixers are sometimes referred to as motionless mixers. A suitable static mixer is shown is FIG. 1, comprising a number of mixer elements in a housing unit. FIG. 1

[symbol]

The length and diameter of the housing unit and number of mixer elements may be adjusted so as to ensure proper mixing.

Within the mixer, the chemical reaction may be controlled such that the chemical reaction initiates (chemical initiation) or is retarded until the reaction mixture enters the pipe reactor, depending on whether the reaction is cooled, allowed at room temperature, or heated in the mixer.

In a suitable embodiment, the mixer is heated so as to heat the reaction mixture. In a suitable embodiment of the processes of the invention, the mixer is heated to a tempertature of 0 to 65° C., such as 10 to 65° C., typically 20 to 65° C., more typically, 25 to 60° C., preferably 30 to 60° C., even more preferably, 35 to 60° C., such as 40 to 60° C., most preferably 40 to 55° C.

Upon leaving the mixer to enter the pipe reactor, mixture is typically a polymerization-initiated mixture, wherein said polymerization-initiated mixture has an elasticity modulus G′ of 0.2 to 15 Pa, such as 0.3 to 10 Pa, 0.5 to 6 Pa, typically 0.5 to 5 Pa.

A problem with conventional continuous processes for the preparation of polymers is that unreacted monomers surpass the gel front in the pipe reactor. This results in product inhomogeneity and this highly undesirable problem is unresolved within the polymer process industry. The present investigators have remarkably found that by allowing reaction mixture to form a premature gel within the mixer, such as by extending the residence time in the mixer, when the reaction mixer enters the pipe reactor, the problem of unreacted monomer surpassing the gel front is not observed.

Correspondingly, a further object of the invention independently relates to a process for the preparation of a substantially uniform polymer hydrogel in a continuous process comprising a polymerisation reaction said reaction comprising the steps of

(i) combining a monomer component, a cross-linking component, and an initiator, or inert premixtures thereof;

ii) mixing the monomer component, cross-linking component, and optionally the initiator or promoter, or inert premixtures thereof until the resulting polymerization-initiated mixture is a premature gel with an elasticity module G′ of 0.75 to 2.5 Pa;

iii) providing said polymerization-initiated mixture through a pipe reactor such that the mixture flows in a net longitudinal direction; said providing resulting in the substantially uniform polymer hydrogel.

Most preferably, in order to best achieve product homogeneity, the polymerization-initiated mixture is a premature gel with an elasticity of 0.8 to 2 Pa.

Thus, in the embodiment wherein the processes or methods of the invention are continuous, it is preferred to start the polymerization in the mixer element to a degree so as to form a premature gel.

When the polymerization reaction is started already in the static mixer element the reactive mixture is converted into a premature gel condition when it leaves the static mixer element and thereby it is avoided that that non polymerized reactive monomer mixture surpasses the gel front and come out of the reactor in a only partly polymerized state. Avoiding the surpassing of unreacted monomer is important in order to obtain a homogeneous gel product where all of the polymeric gel material has the same residence time within the reactor resulting in a homogeneous product with uniform physical properties.

The remaining part of the reaction process in the tube reactor functions as a post-polymerization reactor zone where the final conversion of the reactive monomers within the gel material is taking place in order to obtain a high conversion and a low amount of residual monomer.

The necessary degree of conversion in order to be able to classify the gel to be in the premature gel state is very difficult to define with precise physical properties in as much as it is very much depending of the nature and chemical composition of the polymer network in process. As stated, according to the present invention, the premature gel has an elasticity module G′ of 0.75 to 2.5 Pa, preferably the polymerization-initiated mixture is a premature gel with an elasticity module G′ of 0.8 to 2 Pa.

The present investigators have developed a simple test method in order to determine and design the necessary length of the static mixer zone in the tube reactor and necessary residence times in order to obtain the premature gel condition, when it leaves the mixer zone. The method consists of a system wherein, whilst the system is running and a steady state condition is obtained, a minor amount of colorant is added to any one of the monomer components or inert premixtures thereof. By visual inspection, the operator performing the process of the invention can see whether a coloured front of reactive liquid forms a plug flow or whether the coloured liquid is surpassing the gel front in the reacto.

In the event the coloured liquid does surpass the gel front, the operator can lengthen of the mixer zone until no coloured reactive liquid material surpasses the gel front in the part of the tube reactor following the mixing zone. The operator may alternatively increase the residence time in the mixer by other means such as reducing the gradient pressure. The operator may increase the temperature of the mixer, if the reaction conditions permit this, in order to increase the degree of polymerisation in the mixer so as to form a pre-mature gel.

In a suitable embodiment, the mixer zone may be divided into sections, e.g. A1, A2, and A3, where the A1 and A3 zones contain a static mixer element and where zone A2 does not contain any static mixer element, or a reduced density of static mixer elements. This design of the mixer zone may be preferential in order to ensure adequate feed flow mixing in zone A1 and in zone A3 by the increased flow through A2. It is essential to ensure mixing of reactive species to avoid separation between liquid film monomer and premature gel formation in as much as this situation may cause the above mentioned problem of liquid surpassing the gel in the following tube reactor. Hence the zone A2 may or may not contain static mixer elements, but preferably the zone is without mixer elements in order not to contribute to the line pressure, which will increase risk of any liquid flow to surpass the forming gel in the system. Zone A2 is contributes to the residence time before the flow leaves zone A3. As the skilled person in the art will know, the mixer may comprise any number of repeated combinations of systems of A1, A2 and A3.

The length of zone A1 is typcially set according to the supplier of static mixer elements and will depend on mixer diameter, blade angle of the single mixer elements and geometry. Suitably, the length of zone A3 is a factor of 1 to 5 that of A1 in as much the mixer element being the same. Within such an embodiment, one of the mixing components demonstrates visco-elastic flow, requiring the addition of energy to the mixing step. Typically, the length of zone A3 is thus longer than zone A1.

It is important also with this setup that no reactive liquid bypasses the gel front in the tube reactor connected with the outlet from mixer zone A3. The different zone A1-A3 is adjustable, and the necessary length can be determined according to the specific reaction conditions which are set according to the intended product characteristics, such as elasticity, viscosity, and solid content.

Thus, the method and processes of the invention may comprise a mixing step which in turn comprises a mixing stage wherein the monomer component, cross-linking component, the initiator, or inert premixtures thereof are mixed; said mixing stage followed by a relaxation or flow stage; followed by a second mixing stage wherein the resulting polymerization-initiated mixture is a premature gel having an elasticity module G′ of 0.75 to 2.5 Pa, preferably the polymerization-initiated mixture is a premature gel with an elasticity module G′ of 0.8 to 2 Pa.

Experimentally, the stay-time in the mixer has been determined by use of the colour method described above. The empirical stay-times may be correlated with the gel point, i.e. the point at which the propagated monomer units are building up just to start the first immobilizing network and at which time it is generally accepted that the elasticity modulus G′=1 Pa. The investigators have found that the mixture residence time can be predetermined by having the liquid mixture exist the mixer when 0.5 Pa≦G′≦5 Pa and preferably 0.8 Pa≦G′≦2 Pa. If extending the stay-time beyond 5 Pa the forming gel at mixer exit may be difficult to move due to high resistance at last mixer elements, and the final gel performance may be compromised. If the stay-time is below 0.2 Pa, the liquid mix-up easily occurs as can be visually demonstrated by the colour method.

Product homogeneity may be achieved solely by means of allowing the polymerization-initiated mixture to be a premature gel or in combination with controlling the temperature within the reaction process.

As stated, in a very suitable embodiment, the temperature differential between any two points within the mixer is no more than 9° C., such as no more than 8° C., 7° C., 6° C., 5° C., 4° C., or 3° C.

Thus the process of the invention, in a combination of embodiments may comprise a polymerisation reaction said reaction comprising the steps of

(i) combining a monomer component, a cross-linking component, and an initiator, or inert premixtures thereof;

ii) mixing the monomer component, cross-linking component, and optionally the initiator or promoter, or inert premixtures thereof until the resulting polymerization-initiated mixture is a premature gel with an elasticity module G′ of 0.75 to 2.5 Pa;

iii) providing said polymerization-initiated mixture through a pipe reactor such that the mixture flows in a net longitudinal direction; said providing resulting in the substantially uniform polymer hydrogel;

said process comprising limiting a temperature differential between any two positions within the reactor to no more than 9° C. or limiting a temperature differential between any two positions within the mixer to no more than 9° C.

The temperature differential may, in some embodiments, be no more than 9° C. between any point in the mixer and any point in the pipe reactor.

In a suitable embodiment of a continuous in-line cross-linking (ILX), two inert monomer mixtures A and B fed into the static mixer, wherein A1 is the primary mixing zone, A2 is a relaxation zone (without static mixer) which adds to the needed residence time for obtaining appropriate mixing in the following zone, and A3 is the final mixing zone preventing any liquids from surpassing the gel front and allowing the formation of the premature gel before the reaction mixture enters the tube reactor, where post-polymerization occurs. The inlet may be pre-set at temperature T1, and mixer zones as well as tube reactor may be pre-set at same or different temperatures, T2 and T3.

T1, T2 and T3 may be independently selected from the temperature selected from of 0 to 65° C., such as 10 to 65° C., typically 20 to 65° C., more typically, 25 to 60° C., preferably 30 to 60° C., even more preferably, 35 to 60° C., such as 40 to 60° C., most preferably 40 to 55° C.

In a suitable embodiment of a batch in-line cross-linking process with two monomer mixtures A and B fed into the static mixer wherein A1 is a mixing zone, A2 is a transfer zone from the in-line flow to the mould A3, said mould being where polymerization occurs over a period much exceeding the residence time in the in-line system. If further mould A4, A5, A6, etc. follow, after filling up the first mould by a conveyor step movement, the process may be considered semi-continuous. The inlet may be pre-set at temperature T1, and mixer zone as well as the mould(s) may be pre-set at same or different temperatures, T2 and T3.

As stated, a first object of the invention relates to a method of providing a polymer hydrogel with high homogeneity by a process comprising limiting a temperature differential between any two positions within the pipe reactor to no more than 9° C.; said process comprising providing a polymerization-initiated mixture through a pipe reactor such that the mixture flows in a net longitudinal direction; said providing resulting in polymer formation.

The temperature differential between any two positions within the reactor can be controlled, at least in part by selection of a pipe reactor with an appropriate diameter. Preferably, the pipe reactor has a construction selected from the group consisting of

a) a diameter of no more than 25 mm at a monomer concentration of 1 to 6% (wt/wt) and a polymer-formation temperature of 5 to 65° C.;

b) a diameter of no more than 15 mm at a monomer concentration of 6.1 to 10% (wt/wt) and a polymer-formation temperature of 5 to 65° C.

c) a diameter of no more than 10 mm at a monomer concentration of 10.1 to 22% (wt/wt) and a polymer-formation temperature of 5 to 65° C.

Preferably, the pipe reactor has a diameter of no more than 20 mm at a monomer concentration of 1 to 6% (wt/wt) and a polymer-formation temperature of 5 to 65° C. Preferably, the pipe reactor has a diameter of no more than 10 mm at a monomer concentration of 6.1 to 10% (wt/wt) and a polymer-formation temperature of 5 to 65° C. Preferably, the pipe reactor has a diameter of no more than 9 mm at a monomer concentration of 10.1 to 22% (wt/wt) and a polymer-formation temperature of 5 to 65° C.

More typically, the pipe reactor has a diameter of no more than 25 mm at a monomer concentration of 1 to 6% (wt/wt) and a polymer-formation temperature of 5 to 60° C. Typically, the pipe reactor has a a diameter of no more than 15 mm at a monomer concentration of 6.1 to 10% (wt/wt) and a polymer-formation temperature of 5 to 60° C. Typically, the pipe reactor has a diameter of no more than 9 mm at a monomer concentration of 10.1 to 22% (wt/wt) and a polymer-formation temperature of 5 to 60° C.

The temperature differential between any two positions within the reactor can be controlled, at least in part by selection of a pipe reactor made of materials with adequate heat conductivity. The processes and methods of the invention typically comprises pipe reactor substantially consisting of a material selected from the group consisting of teflon, stainless steel, glass, plastic, ceramic and combinations thereof.

Heat conductivity is dependent on features other than the material of the pipe reactor, including the flow of the reaction mixture and the concentration of the monomers in the reaction mixture. It is therefore more appropriate to relate to the process in terms of the heat flux.

In a typical embodiment, the pipe reactor has a heat flux of 0.0.01 to 60 J/sec, such as 0.01 to 50 J/sec, such as 0.05 to 45 J/sec, 0.1 to 40 J/sec, 0.15 to 40 J/sec, 0.15 to 35 J/sec, 0.15 to 30 J/sec, 0.15 to 25 J/sec, 0.15 to 20 J/sec.

Typically, in the embodiment wherein the pipe reactor has a diameter of 1 to 12 mm, the heat flux is 0.01 to 10 J/sec, such as 0.05 to 8, typically 0.1 to 8, such as 0.15 to 8 J/sec. Also typically, in the embodiments wherein the pipe reactor has a diameter of 12.1 to 30 mm, the heat flux is 0.2 to 60 J/sec, such as 0.25 to 50 J/sec, such as 0.3 to 45 J/sec, such as 0.4 to 40 J/sec, typically 0.5 to 40 J/sec.

Typically for a monomer concentration of 1 to 6% (wt/wt), the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

Typically, at a monomer concentration of 6.1 to 10% (wt/wt), the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

Typically, at a monomer concentration of 10.1 to 22% (wt/wt), the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

An important object of the invention may be alternatively defined as a method for controlling the temperature differential between any two positions within a reactor in a process for the preparation of a polymer hydrogel comprising a polymerisation reaction comprising the steps of:

(i) combining a monomer component, a cross-linking component, an initiator, and optionally a promoter, or inert premixtures thereof, in a mixer;

said combining resulting in a polymerization-initiated mixture;

ii) providing said polymerization-initiated mixture through a pipe reactor such that the mixture flows in a net longitudinal direction; said providing resulting in polymer formation; wherein polymerisation reaction is a condensation or radical polymerization; wherein said pipe reactor having a construction selected from the group consisting of

a) the pipe reactor having a diameter of no more than 25 mm at a monomer concentration of 1 to 6% (wt/wt) and a polymer-formation temperature of 5 to 65° C.;

b) the pipe reactor having a diameter of no more than 15 mm at a monomer concentration of 6.1 to 10% (wt/wt) and a polymer-formation temperature of 5 to 65° C.;

c) the pipe reactor having a diameter 10 mm at a monomer concentration of 10.1 to 22% (wt/wt) and a polymer-formation temperature of 5 to 65° C.

Preferably, the temperature differential between any two positions within the pipe reactor is of no more than 8° C., such as no more than 7° C., 6° C. preferably no more than 5° C., even more preferably no more than 4° C.

The pipe reactor may have a diameter in the range of about 1 to 50 mm, such as in the range of about 5 to 25 mm, preferably in the range of about 7 to 20 mm, such as about 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5 and about 20 mm.

An essential feature of the method of the invention is that the diameter and/or construction of the pipe reactor is such that the temperature differential between the temperature at the interface between the outer wall of the reactor and the temperature of the solution mixture anywhere else in the pipe reactor is no more than 9° C. As shown in the Examples, temperature variations with a preparation results in non-homogenous hydrogels in terms of rheological properties and appearance. The use of a teflon pipe reactor with an internal diameter of either 9.55 mm or 18 mm and a wall thickness of 1 and 1.5 mm, respectively, achieved limiting temperature variations to less than 3° C. Thus, in a preferred embodiment, the temperature differential between the temperature at the interface between the outer wall of the reactor and the temperature of the solution mixture anywhere else in the pipe reactor is no more than 4° C., more preferably no more than 3° C.

The present investigators have found that with a pipe reactor diameter of 8 mm, temperature variations in the reaction medium were about 2 to 3° C., whereas when the same reaction conditions were performed with a 18 mm-diameter pipe reactor, the temperature variation was approximately 5° C. However, the reaction conditions may be altered such that the temperature variations within the 18 mm-diameter is also less than 5° C.

In the embodiment wherein high viscosity gels are being prepared by the method of the invention, temperature control is more difficult due to the lower likelihood of chain-terminating reactions.

The present investigators have found that steel is, in some embodiments, a more appropriate material for the pipe reactor than teflon as temperatures variations in the reaction mixture were even lower when steel was used than teflon, presumably due to the greater capacity of steel to distribute heat to the surrounding cooler environment.

The length of the pipe reactor may vary according to the polymerisation conditions, such as temperature, pressure, and component ratios. The time of reaction may also vary according to the polymerisation conditions, such as temperature, pressure, reactor length, and component ratios.

The pipe reactor, may be in a horizontal, vertical or diagonal position. In a suitable embodiment, the tube reactor is in a vertical position which enables for a better sealing effect of the gel material formed against the wall of the tube reactor, thereby avoiding that unpolymerised liquid monomer downstream overtake the gel front. This is done by the movement in the small cavities that are created along the tube reactor due to polymerisation contraction or differences in thermal contractions of the materials involved.

In a suitable embodiment, the pipe reactor comprises a co-axial arrangement wherein the polymerisation reaction is cooled or heated from an inner pipe and an outer pipe. Cooling or heating may be accomplished using a fluids or gases. Means of heating or cooling known to the person skilled in the art are also anticipated.

In a particular interesting embodiment of the present invention, the polymer hydrogel is polyacrylamide. The processes of the invention may thus comprise the steps of

(i) combining an acrylamide component, methylene bis-acrylamide component, and a radical initiator component, or inert premixture components thereof in a mixer said combining resulting in a polymerization-initiated mixture

ii) providing said polymerization-initiated mixture through a pipe reactor such that the mixture flows in a net longitudinal direction

said pipe reactor having a construction such that a temperature differential of no more than 9° C. is present between any two non-longitudinal positions within the reactor.

Typically the combining step is performed with amounts of the acrylamide component, methylene bis-acrylamide component, and a radical initiator component so as to obtain a polyacrylaminde hydrogel comprises 0.5 to 25% wt/wt polyacrylamide.

Preferably, the combining step comprises combining an inert premixture solution A with inert premixture solution B wherein solution A comprises acrylamide, methylene-bis-acrylamide, TEMED and optionally water; and solution B comprises AMPS and optionally water.

Typically, the combining step comprises acrylamide and methylene-bis-acrylamide in a molar ratio of about 200:1 to 1000:1, such as about 200:1 to 900:1, such as about 200:1 to 800:1, such as about 250:1 to 800:1, such as about 250:1 such as about 300:1, 400:1, 500:1, 600:1, 700:1, 800:1. Particularly, excellent and uniform gels were prepared ratios of about 290-310:1, about 480-490:1.

In the embodiment wherein the polymer is polyacrylamide, a preferred embodiment is one wherein the pipe reactor has a construction selected from the group consisting of

a) a diameter of no more than 25 mm at a monomer concentration of 1 to 6% (wt/wt) and a polymer-formation temperature of 5 to 65° C.;

b) a diameter of no more than 15 mm at a monomer concentration of 6.1 to 10% (wt/wt) and a polymer-formation temperature of 5 to 65° C.

c) a diameter of no more than 10 mm at a monomer concentration of 10.1 to 22% (wt/wt) and a polymer-formation temperature of 5 to 65° C.

In the embodiment wherein the polymer is polyacrylamide, a preferred embodiment is one wherein the pipe reactor has a construction selected from the group consisting of

a) a diameter of no more than 20 mm at a monomer concentration of 1 to 6% (wt/wt) and a polymer-formation temperature of 5 to 65° C.;

b) a diameter of no more than 10 mm at a monomer concentration of 6.1 to 10% (wt/wt) and a polymer-formation temperature of 5 to 65° C.;

c) a diameter of no more than 9 mm at a monomer concentration of 10.1 to 22% (wt/wt) and a polymer-formation temperature of 5 to 65° C.

In the embodiment wherein the polymer is polyacrylamide, it is preferred that the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

Thus, in the embodiment wherein the polymer is polyacrylamide, the mixer may be heated to a temperature of 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

Further, in the embodiment wherein the polymer is polyacrylamide, the pipe reactor may be heated to a temperature of 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

Furthermore, the inert premixtures solution A and solution B may be pre-heated to a temperature of 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

In the above embodiment wherein the components A and B are combined at 45° C., adequate conversion and typical polymerisation results in a G′ modulus within the scope of the invention within 2000 sec after the mixing of the A and B, more typically within 1800 sec, such as within 1500 sec. Conversion, a measure of the amount of acrylamide polymerised, is affected by the polymerisation temperature and the diameter of the pipe reactor. A 0.5% residual amount of acrylamide monomer corresponds to a conversion of about 90%. This level of conversion is typically achieved within 1000 seconds of mixing of the reactive components.

In a suitable embodiment, the TEMED compound is separated out from the acrylamide/bisacrylamide aqueous solution in the feeding tanks if the polymerization reaction is conducted over a longer period of time of several hours, e.g. over a time span of more than 5 hours. This is recommended since the TEMED might be able to induce hydrolysis of the acrylamide and bis-acrylamide monomers in aqueous solution at higher temperature.

The present invention achieves high uniformity by, independently or in combination, controlling the temperature differential within the system or controlling the level of gel formation within the mixer. The present invention is amenable to all condensation polymerisation reactions but particularly advantageous with reaction mixtures having higher amounts of acrylamide and therefore capable of being even more exothermic than the conventional formulations, e.g. such as low-viscosity and high-viscosity formulations having between 10 to 20 wt % monomers in the aqueous solution. At such concentrations, peak temperatures are recorded at between 66 and 99° C. when they are polymerized in a standard 100-ml beaker. The much higher exotherm is primarily due to the higher monomer concentration.

In the embodiment wherein the polymer is polyacrylamide, the method may involve two or more flows, such as one being a premix comprising acrylic amide and the cross-linking agent, and the other comprising an initiator which are pumped into a static mixer for chemical initiation and subsequent extrusion downstream into a pipe reactor in which polymerization occurs. Judicious selection of the monomer (acrylamide) concentration, cross-linker (methylene bis-acrylamide) concentration, and initiator concentration, in both the relative and absolute sense, as well as by regulation of the at least two flow rates, mixing temperature, and polymerization temperature, it is possible to tailor the degree of cross-linking, the solid-weight content, the rheological properties and thus the tailoring the production of the gels to their specific intended use.

By selecting acrylamide, cross-linker and initiator concentrations and their relative molar ratios, and by regulating the two flow rates and the polymerisation temperatures, it is possible to produce gels that are varying in degree of crosslinking and in solid content.

The combining involves the combining of the component reagents, typically degassed and typically in a manner to minimise operator contact. The reagent components may be optionally previously combined to form an inert mixture. An inert mixture is one wherein no chemical reaction proceeds among the component reagents. The combining involves combining acrylamide, methylene-bis-acrylamide, and a radical initiator component. In a suitable embodiment, an inert premixture of acrylamide, methylene-bis-acrylamide (the cross-linker) and TEMED is combined with an AMPS initiator solution. However, the components may be combined as singularities or as alternative plural premixtures.

The present investigators have found that the process for the preparation of polyacrylamide may be performed without the addition of a promoter, such as TEMED. The process for the preparation of a polymer hydrogel typically comprises ammonium persulfate as the initiator.

At higher amounts of AMPS, the chain length of the individual polymer molecules formed are shorter resulting in a lower amount per molecule-chain of crosslinker and therefore also in an overall lower density of crosslinks per volume gel. This gives rise to the lower modulus/viscosity and, if the amount of AMPS is high enough, to the possibility of formation of larger amounts of non-crosslinked materials (leachables).

In a suitable embodiment, a chain-transfer agent is optionally added to the reaction mixture. This will provide higher molecular weight products. Increasing the amount of initiator will also provide higher molecular weight products. However, an increase in relative amount of initiator results typically in higher peak temperatures, which ma translate into higher temperature variations.

Acrylamide and methylene-bis-acrylamide are suitably combined in a molar ratio of about 100:1 to 1000:1, typically about 150:1 to 900:1, preferably about 175:1 to 800:1, more preferably about 200:1 to 600:1, most preferably from 250:1 to 500:1. As shown the Examples, hydrogels of differing solid-weight content and rheological properties may be controllably prepared by this method, demonstrating the advantageous versatility. An illustrative preparation of the hydrogel according to the present invention is described in Example 2. The hydrogel having the desired rheological characteristics has been obtained by combining acrylamide and methylene-bis-acrylamide in a ratio of about 250:1, about 260:1, about 270:1, about 280:1, about 290:1, about about 300:1, about 310:1, about 320:1, about 330:1, about 340:1, about 350:1, about 360:1, about 370:1, about 380:1, about 390:1, about 400:1, about 410:1, about 420:1, about 430:1, about 440:1, about 450:1, about 460:1, about 470:1, about 480:1, about 490:1 and about 500:1.

As can also be seen from the Examples, the relative amount of monomer (acrylamide and methylene-bis-acrylamide) is fairly constant from formulation to formulation in relation to the redox agent. Thus, in a preferred embodiment of the method of the invention, the ratio of monomers to redox agent is relatively constant from batch to batch and not used to regulate the rheological properties of the polymer. In the embodiment wherein the polymer is polyacrylamide, the ratio of the monomers acrylamide and methylene-bis-acrylamide to TEMED is about 100:1 to 700:1, such as 200:1 to 600:1, typically 200:1 to 500:1, preferably 200:1 to 400:1, most preferably 200:1 to 350:1.

Similarly, the relative amount of monomer (acrylamide and methylene-bis-acrylamide) is fairly constant from formulation to formulation in relation to the amount of initiator. Thus, in a preferred embodiment of the method of the invention, the ratio of monomers to initiator is relatively constant from batch to batch and not used to regulate the rheological properties of the polymer. In the embodiment wherein the polymer is polyacrylamide, the ratio of the monomers acrylamide and methylene-bis-acrylamide to initiator is about 100:1 to 700:1, such as 200:1 to 600:1, typically 200:1 to 500:1, preferably 200:1 to 400:1, most preferably 200:1 to 350:1.

The relative amounts of the components may be suitably adjusted by the relative concentrations of the components in a premixture or regulating the flow rate of the plural or singular solutions. Thus, the method of the invention allows for controlling relative ratios both by concentrations of mixtures and pressurised flow rates of solution components.

The individual components or the premixtures may be optionally heated prior to mixing or during the mixing process. The monomer solutions or inert mixtures thereof may be in a closed system and pumped into the static mixer. The individual flow rates, concentrations, and temperatures of the solutions may be varied and tailored to the desired gel. The pressure ensures a mixing speed such that viscous solutions/mixtures are well mixed. This is of great importance with regards to the homogeneity of the gel.

The reaction may be performed in water, saline solution, alcohols, provided that upon production of the network structure, the reaction solvent can be exchanged with water or saline solution to form the hydrogel.

In a preferred embodiment, the method of the invention provides a hydrogel with a solid weight content of between about 1 and 20% polyacrylamide, based on the total weight of the hydrogel, typically between 1 and 10% polyacrylamide. In one suitable embodiment of the invention, the hydrogel obtainable or obtained by the method of the invention has a solid-weight content of less than 3.5% polyacrylamide, based on the total weight of the hydrogel. In another suitable embodiment of the invention the hydrogel obtainable or obtained by the method of the invention has a solid-weight content of less than 1.6% polyacrylamide, based on the total weight of the hydrogel, such as less than 1.5% polyacrylamide, based on the total weight of the hydrogel. In an alternative embodiment of the invention, the hydrogel obtainable or obtained by the method of the invention has a solid-weight content of more than 3.5% and less than 6% polyacrylamide, based on the total weight of the hydrogel. In a further alternative embodiment of the invention, the hydrogel obtainable or obtained by the method of the invention has a solid-weight content of more than 6% and less than 9.5% polyacrylamide, based on the total weight of the hydrogel. In a still further suitable embodiment of the invention, the hydrogel obtainable or obtained by the method of the invention has a solid-weight content of more than 9.5% and less than 25% polyacrylamide, based on the total weight of the hydrogel.

In a especially preferred embodiment of the invention, the process comprises combining acrylamide and methylene bis-acrylamide in a molar ratio of 150:1 to 1000:1, radical initiation, and washing with pyrogen-free water so as to give a hydrogel with less than 3.5% by weight polyacrylamide.

As can be seen from the hydrogels obtained and described in Tables 1, 2, and 3, the hydrogel according to the present invention preferably has a complex viscosity of up to 3000 Pa s, such as up to 2000 Pa s, preferably up to 1000 Pa s.

Low to high viscosity gels typically have a complex viscosity of about 2 to about 90 Pa s, such as 5 to 80 Pa s, typically from about 6 to 76 Pa s, such as from about 6 to 60 Pa s, 6 to 40 Pa s, 6 to 20 Pa s, such as 6 to 15 Pas.

The hydrogels of the invention have been prepared in low viscosity formulation, medium viscosity formulations, and high viscosity formulations. Thus, in a suitable embodiment of the invention, the hydrogel obtainable or obtained by the process of the invention has a viscosity ranging from 2 to 15 Pa s, namely a low viscosity hydrogel. Similarly, in a further suitable embodiment of the invention, the hydrogel obtainable or obtained by the process of the invention has a viscosity ranging from 16 to 30 Pa s, namely a medium viscosity hydrogel. Likewise, in a still further suitable embodiment of the invention, the hydrogel obtainable or obtained by the process of the invention has a viscosity ranging from 31 to 60 Pa s, namely a high viscosity hydrogel.

In a suitable embodiment of the invention, the hydrogel has a degree of cross-linking such that it has complex viscosity of not less than 2 Pa s, such as not less than 3, 4 or 5 Pa s, such as not less than 5.5 Pa s, such as not less than 6 Pa s, preferably not less than 6.2 Pa s.

The polyacrylamide hydrogel of the invention is obtainable by the method and processes of the invention. The method and processes of the invention may be a continuous process for the preparation of polymers, such as condensation products of radical polymerisation, such as cross-linked polyacrylic amide gel (PAAG). The method is flexible in that a variety of polymers may be prepared therefrom and a variety of desired rheological and mechanical gel properties are obtainable for each polymer, and adaptable to the intended use or uses of the polymer or gel.

The present investigators have reduced the washing time from 92 hrs to about 22 hrs for polyacrylamide hydrogels. The washing operation can be optimised with respect to a further reduction of the washing time required to obtained the low level of residual acrylamide for a desired polyacrylamide solid content. The present investigators have established a relationship between the diffusion profile (geometric structure of the gel material, temperature) for the acrylamide leaving the gel material and the simultaneous running water up-take by the gel material.

The convention process may comprise washing the polymer hydrogel. Removal and swelling of the gel using the conventional process is laborious and requires approximately one week to either effectively remove the monomer or swell the gel to the desired weight content to have the desired rheological properties.

The present investigators have remarkable lowered the washing time to remove monomers whilst effectively swelling the gel in as little as about half a day, such as 22 hours. The processes and methods of the invention may further comprise a washing step.

A further object of the invention relates to a method for preparing a biocompatible polymer hydrogel comprising the steps of providing a hydrogel so as to have a specific surface area of at least 1.5 cm²/g and contacting said hydrogel with an aqueous medium until the polymer comprises an amount of monomer below the toxicity threshold for said monomer to the human body.

Conversely, the conventional process provides the hydrogel so as to have a specific surface area of under 1 cm²/g, typically about 0.73 cm²/g.

The washing step of the invention comprises the use of a solvent wherein the monomer is soluble and wherein the hydrogel is insoluble. The washing step further comprises contacting the polymer with an aqueous solution. The aqueous solution may be selected from water, saline solution and aqueous alcohol solutions. The contacting of the polymer with the aqueous solution is performed until the residual amount of monomer is less than 400 ppm, typically less than 300 ppm.

The washing step typically comprises contacting a solvent with the polymer, wherein the polymer has a specific surface area of at least 1.5 cm²/g, such as at leas 2 cm²/g, at least 3 cm²/g, at least 4 cm²/g, typically at least 5 cm²/g, at least 6 cm²/g, at least 7 cm²/g, preferably at least 8 cm²/g. The washing step is performed until the level of the monomer in the polymer is below the toxicity threshold for the monomer to the human body.

An object of the invention may be defined as a method of removing monomeric units from a polymer hydrogel comprising providing the polymer hydrogel so as to have a specific surface area of at least 1.5 cm²/g; washing the polymer hydrogel such that the level of monomeric unit in the hydrogel is less than 400 ppm with an aqueous medium.

The providing the polymer hydrogel so as to have a specific surface area of at least 1.5 cm²/g and then contacting the polymer hydrogel with an aqueous medium until the desired solid-weight content is obtained. Typically, the desired solid-weight content is 1 to 20% polyacrylamide.

The washing process seeks primarily to extract toxic amounts of acrylamide, methylene-bis-acrylamide, and initiators rendering the gel biocompatible. The washing process is a swelling process wherein the polymer takes in water. The swelling process is in competition with the extraction process of the residual monomers and initiator fragments in the sense that the low level of residual monomers should be obtained within the same time as it takes for the gel to take up the desired amount of water.

The washing process, by remove residual monomers, renders the hydrogel biocompatible. Typically, the washing process is to be done in such a manner and for such as duration so as to lower the residual monomeric content to no more than 50 ppm, preferably no more than 40 ppm, such as no more than 30 ppm, more preferably no more than 20 ppm, even more preferably no more than 10 ppm, most preferably no more than 5 ppm, such as no more than 4 or 3. Regulatory standards for acceptable levels of residual monomeric content in order for the gel to be considered biocompatible may vary but are often set at no more than 10 ppm, more often no more than 5 ppm.

Water uptake and swelling is very dependent on geometry of the sample, whereby larger surface-area to bulk-weight ratio gives rise to much more faster rates of water uptake.

Thus, in a preferred embodiment, the gel extruded from the pipe reactor has a large surface-area/bulk-weight ratio. The swelling and extraction process is also affected by the water temperature used in the washing process. The present investigators have surprisingly found that lower water temperatures reduce the swelling rate whilst not affecting the extraction efficiency to any appreciable degree. The washing may be performed in the range of 2 to 80° C., such as 5 to 60° C.

The present investigators have found that when it is intended to have a short washing time in order to have a high solid weight content without having a detrimental affect on the level of residual monomer, it is preferable to wash at low temperatures. Lowering the washing temperature slows the swelling process without reducing the extraction of monomers.

The washing may be done using water or a saline solution. The washing process may be facilitated by the use of ultrasound.

The washing of the hydrogel will alter the solid-weight content of the hydrogel, as the gel swells with water or saline solution. The process of the invention is typically such that the biocompatible hydrogel has comprised from 0.5 to 25% polyacrylamide by weight, based on the total weight of the hydrogel. Gels with solid weight content of about 0.5 to 25% polyacrylamide by weight, based on the total weight of the hydrogel, have been prepared and are shown in the Examples.

The method of the invention is suitable for preparing layered products wherein a product with multiple layers of identical or different hydrogels are produced in an in-line process The washing step is preferably performed immediately after the polyacrylamide gel is formed in order to reduce the possible degradation of the gel initiated by the residual TEMED.

In particularly interesting embodiments of the present invention, the process results in a polymer hydrogel of a hybrid system of more than one polymer-type. The hybrid system may be a multiple-polymer system of at least two polymer types, said multiple-polymer system structured in an arrangement selected from the group comprising a co-axial arrangement and an adjacent arrangement.

In the hybrid system, the polymer types may be in an adjacent arrangement. The polymer formation step is performed at least twice so as provide a first and a further polymer-type and the first and further combining or providing step for the first and further polymer-type are performed in a non-identical manner and said process further comprising layering the first and further polymer-type to have surface area contact to the polymer-type provided by the preceding polymer formation. The surface area contact may be direct or mediated through a coating. The surface area contact may only be a small fraction of the surface area. The optional coating mediating the layers may be an adhesive.

In one interesting embodiment of the present invention, at least one polymer is doped with a doping agent selected from the group consisting an anaesthetic, an anti-septic, an anti-fungal, an antibiotics, an anti-coagulant, an adstringentic, a anti-inflammatory, an NSAID, a keratolytic agent, an epithelial growth hormone, a growth factors, a sex hormone, a cytostatic, an anti-cancer agent, a colouring agent, and a radioactive agent.

According to the present invention, it is possible to make doped hydrogel materials with different active compounds or compositions and with different concentration profiles. In layered or coaxially arranged products it will be possible to have different composition and concentration profiles in the different layers.

In an illustrative example, a colorant is added for a new technical effect. In the event the acrylamide is used for increasing the bulk, such as in a conduit such as the urethra, visualisation of the degree of bulk is problematic given the clear appearance of polyacrylamide hydrogel, The use of a colorant allows the operator to identify and administer the hydrogel in the correct position and in the correct amounts.

Any colorant which is not detrimental to the integrity of the gel nor toxic to human tissue is suitable in this context, such as Blue-Hema, Methylene Blue and Indigo Carmine. Colorants known to the person skilled in the art are anticipated by the present invention.

The colorant may be added during the combining step before the polymerization is conducted or it can be added to the washing water used in the washing operation.

The doping agent may be pre-dispersed in the polymer forming solution and hence being imbedded in the polymer hydrogel suitable for sustaining the diffusion of the active ingredients from the polymer hydrogel to the outer surface and hence acting as a sustained drug delivery system. This may be used in embodiments wherein the hydrogel is used as an prosthetic.

In an alternate embodiment, the doping agent is pre-dispersed in a separate vehicle suitable for high doping capacity, agent dispersability and chemical/physical stability, and introduced to the hybrid system as a functional surface coating compatible with the adjacent polymer or as a functional interlayer coating thereby providing control over the doping agent diffusion from the vehicle into the surrounding polymer, adjacent polymer or to the outer polymer surface and hence acting as a controlled drug delivery system.

In a suitable embodiment of hybrid systems, at least one polymer contains a conducting agent selected from the group comprising ionic polymers, dissociative metallic inorganic compounds and organic compounds. The conducting agent may pre-dispersed during the combining step and hence being imbedded in the polymer hydrogel facilitating ionic transport in the wet hydrogel environment and hence acting as a vehicle battery.

In a further suitable embodiment of hybrid systems, at least one polymer is acting as a degradable or a non-degradable tissue growth network directly or, by introduction of structural additives, facilitating epithelial growth in the combining step. The additives may pre-dispersed in the polymer forming solution and hence being imbedded in the polymer hydrogel.

An important object of the present invention relates to substantially uniform polymer hydrogels obtainable and obtained by the methods and processes of the invention. Particularly, this aspect of the invention relates to a polyacrylamide hydrogel obtainable according to a process or method defined herein. The present investigators have provided polyacrylamide hydrogels which are substantially uniform to the field of polymer chemistry and or prosthetics for the first time.

Moreover, the present investigators have developed a process for preparing powdered polyacrylamide hydrogel. A further aspect of the invention thus relates to polyacrylamide hydrogel obtained by the following process: i) combining an acrylamide component, methylene bis-acrylamide component, and a radical initiator component, or inert premixture components thereof;

ii) mixing the acrylamide component, methylene bis-acrylamide component, and the radical initiator component, or inert premixture components thereof until the formation of the polyacrylamide hydrogel;

iii) contacting a the polyacrylamide hydrogel with a solvent which is miscible with water and which is soluble to the acrylamide component or methylene bis-acrylamide and which is not a solvent for the polymer, said solvent provided in excess so as to extract the water from the hydrogel as well as the acrylamide component or methylene bis-acrylamide until a white solid polymer is precipitated.

The solvent is selected from methanol, ethanol, propanol, butanol and derivatives thereof, preferably ethanol, propanol and butanol, more preferably ethanol. In the embodiment wherein the solvent is ethanol, it isprovided in an excess so as to be in about 10-fold to 100-fold excess with respect to the amount of water.

The solvent results in the precipitation of a white, solid polymer from the solvent mixture, and the precipitate may be isolated by centrifugation or by a filtration operation. The precipitated polymer may be dried, such as in a vacuum oven, to remove excess solvent. The dried polymer may be sold as such as a powder of in pieces of various sizes. The dried polymer may rehydrated with an aqueous medium to a desired solid content level.

This process is particularly interesting in the event extremely low amounts of residuals e.g. in the ppb range, is desirable in the polyacrylamide gel, especially since the rehydrated product may go through another precipitation—rehydration cycle.

It is possible to use other precipitation solvents (non-solvents) than ethanol, and the solvents can easily be identified by comparing Hansen solution parameters or by performing small laboratory experiments showing that the non-solvent is miscible with the polymerization solvent and at the same time the non-solvent is capable of precipitating the polymer.

The invention is further illustrated by the following Examples.

### EXAMPLES

### Example 1

Analysis of the Process Based on WO 96/04943

Temperature Measurement of the Process

The temperature was measured at different positions in the 100-ml cylindrical beaker during the polymerisation/casting process with a (NiCr—Ni)-thermocouple connected to an 8-channel thermocouple data logger and a PC.

In Table 1, it is shown how the temperature develops at four different positions in the beaker when the liquid is polymerised into the gel. The time at which gelatinisation of the mixture starts is normally around 120-180 seconds, which corresponds very well with the peak time at the top position. Methods based upon WO 96/04943 results in product inhomogeneity, are difficult to perform reliably, is not conducive to large scale production and allows for very little control of conditions.

TABLE 1
Temperature profile during the polymerisation
of the PAAG in a 100 ml beaker

| Sample | | | | |
|---|---|---|---|---|
| Time | Temperature in ° C. | | | |
| (seconds) | Top | Bottom | Side | Middle |
| 100 | 45.2 | 44.4 | 44.6 | 45.4 |
| 200 | 47.7 | 46.7 | 47.1 | 49.2 |
| 300 | 47.4 | 47.3 | 48.4 | 51.6 |
| 400 | 46.5 | 47.0 | 48.7 | 52.7 |
| 500 | 45.3 | 46.4 | 48.5 | 52.9 |
| 600 | 44.3 | 45.6 | 47.9 | 52.6 |
| 700 | 43.2 | 44.7 | 47.2 | 52.1 |
| 800 | 42.2 | 43.8 | 46.4 | 51.3 |
| 900 | 41.2 | 43.0 | 45.5 | 50.4 |
| 1000 | 40.3 | 42.1 | 44.6 | 49.5 |
| 1100 | 39.3 | 41.4 | 43.8 | 48.6 |
| 1200 | 38.5 | 40.6 | 42.9 | 47.6 |
| 1300 | 37.6 | 39.9 | 42.1 | 46.6 |
| 1500 | 36.1 | 38.5 | 40.5 | 44.7 |
| 1700 | 34.7 | 37.3 | 38.9 | 42.9 |
| 1900 | 33.5 | 36.2 | 37.6 | 41.3 |
| 2100 | 32.3 | 35.2 | 36.3 | 39.7 |

As can be seen from the reviewing the values in Table 1, there is a big difference between the temperature measured in the centre part compared to the temperature measured at the top, the wall and the bottom. It is known that polymer network formed at different temperatures will have different physical structures such as different modulus and viscosities; as verified infra.

Rheolocical Measurements of Products of Conventional Processes

One of the objectives with the rheological measurements was to determine the virgin material characteristics (here the G′-modulus or viscosity) on an undisturbed gel polymerised in a measuring unit at controlled conditions. It was also the intention to use the rheological measurements to follow the advancing curing/polymerisation process of the PAA gel in order to be able to define when the gel has reached its final physical properties and consequently ready for the extraction process.

A concentric cylinder unit called a couette was used in the measurements, and with this unit it is possible to measure at a constant temperature and to avoid major influence from the oxygen in the surrounding atmosphere.

The results from the measurements can be summarised as follows (see Table 2):

the G′-modulus (and viscosity) is very sensitive to the polymerisation temperature;

the G′-modulus (and viscosity) is very sensitive to the amount of AMPS/TEMED;

the upper limit in temperature for formation of a gel material is about 60° C.;

it is questionable if degassing of the monomer-initiator solutions in the way it is done in the process today has any major effect on the curing process (start of reaction, %-conversion, final modulus and viscosity etc.);

the final value for the G′ modulus is obtained within 800-1000 sec after the mixing of the A1 and A2 at 45° C.

TABLE 2
G′-modulus and viscosity as a function of the polymerisation temperature

| Polymerisation | G′-modulus | Gelation time |
|---|---|---|
| temperature in ° C. | (Pa) | (sec) |
| 10 | 580 | 1430 |
| 20 | 510 | 820 |
| 30 | 320 | 460 |
| 40 | 250 | 263 |
| 45 | 150 | 150 |
| 50 | 70 | 150 |
| 60 | 16 | 120 |
| 20 | 2520 | 710⁺ |
| 45 | 2000 | 145⁺ |

The Bolin VOR rheometer was pre-equilibrated at the desired polymerisation temperature for at least 20 minutes before the mixtures were loaded into the cell.
Gelation time is the time in seconds at which the G′ reaches 1 Pa.
⁺6 times the amount of bis-methylene acrylamide The amount of bis-methylene acrylamide in Aquamid ® gel (an embodiment of the present invention) is ⅙ compared to the concentration normally used in the gel electrophoresis PAAG.

Oxygen in the solutions delay polymerisations to some extent, presumably due to quenching of radicals.

Summary of Results of Conventional Process

It has been demonstrated by the temperature profiles measurements that a major temperature inhomogenity in the gel exist during the casting process.

It has been demonstrated by the rheological measurements that the G′-modulus (elasticity) of the hydrogen is very sensitive to variations in the polymerisation temperature. At positions of low temperature, the G′-modulus will be higher than at positions of high temperature sites such as in the middle of the gel cylinder.

These findings demonstrate large variations of the G′-modulus/viscosity within the single 100 gel lumps, and this can explain batch-to-batch variations as well as intra-batch and intra-gel variations in products using conventional processes.

The temperature inhomogenity will also have effects on the % of conversion of the monomers at different places in the gel. In order to be able to produce a gel as homogeneous as possible with regards to important physical performance, it is desirable to be able to minimize the temperature fluctuations within the gel during its production. At the same time it is of course desirable to be able to produce the gel in a simpler and more controllable way, in order to minimize all the other possible variation within the process of today which can affect the homogeneity of the final product. The time of production aspect is a matter of great interest, and it would be desirable is possible to reduce the production time significantly, in order to achieve a higher production output and rendering it possible to operate with many different viscosities and new hydrogels on the same production equipment.

### Example 2

Description of the In-Line Crosslinking Concept

The purpose of the in-line crosslinking process technology was to make a production set-up with the following beneficial properties compared to the state-of-the-art-PAAG production:

easy to operate due to automation (minor risk for mistakes),

a continuous process with no sub-batch level variations,

easy to make changes in the formulations (crosslinking densities, solid content),

easily adjustable in batch size,

easily adjustable to use for the production of “layered” products containing gradients in crosslinking densities,

the polymierisation conditions within the tube reactor can be controlled resulting in a more homogeneous PAAG product (good reproducibility), to reduce the time of production (the extraction process) to minimize the exposure of hazardous monomer solutions to the operators

In a suitable set-up, two individual and eventually degassed flows, one being a pre-mix of acrylic amide, bis-methylene acryl amide (the cross-linker) and TEMED, the other being the AMPS initiator solution, are pumped into a static mixer for mixing, chemical initiation and subsequent extrusion downstream into a pipe reactor made of Teflon in which the polymerization occurs. By selecting monomer, cross-linker and initiator concentrations and their relative molar ratios, and by regulating the two flow rates and the polymerisation temperatures, it is possible to produce gels that are varying in degree of crosslinking and in solids content.

### Example 3

Temperature Profiles of Processes of the Invention

Tube Reactors Having Different Diameters

In investigating applicable diameters of the pipe reactors, measurements have been made monitoring the temperature differences within tubes made of Teflon.

In Table 3, the temperature profiles for the polymerisation (cure/casting) at different temperatures (45, 50, 55 and 60° C.) of the acrylamide mixture within tubes with diameters of 9.55 and 18 mm, each having a length of 17 cm. The pipe reactor with a diameter of 9.55 mm has wall with a thickness of 1 mm whereas the pipe reactor with a diameter of 18 mm has wall with a thickness 1.5 mm.

Prior to filling the pipe reactor with the reaction mixtures of A1 and A2 (ratio 1:1), each pipe reactor was equilibrated in a water bath kept at the desired polymerisation temperature. A thermocouple was placed in the centre part of the tube. Equal amounts of A1 and A2 at RT were degassed, mixed and degassed once again just prior to the filling of the tube.

TABLE 3
Peak time-temperatures for polymerisation reactions in tubes with
different diameters

| | | | | | Time to |
|---|---|---|---|---|---|
| | Polymerisation | Time to reach | | Peak | return to |
| Tube | temperature | polym. temp. | Peak | temperature | polym. Temp. |
| diameter | (° C.) | (sec) | time (sec) | (° C.) | (sec) |
| 9.55 mm | 45 | 190 | 335 | 47.2 | 1040 |
| 9.55 mm | 50 | 200 | 310 | 52.1 | 1035 |
| 9.55 mm | 55 | 200 | 325 | 56.9 | 1030 |
| 9.55 mm | 60 | 215 | 295 | 61.7 | 855 |
| 18.0 mm | 45 | 280 | 430 | 47.6 | 1130 |
| 18.0 mm | 50 | 295 | 440 | 52.2 | 1095 |
| 18.0 mm | 55 | 295 | 415 | 56.6 | 870 |
| 18.0 mm | 60 | 305 | 425 | 61.3 | 775 |

It can be seen from the results in Table 3 that the temperature difference between the wall (=the temp in the water bath) and the centre part of the tube has been narrowed to about 1.3-2.6° C., which is a clear improvement compared to the results obtained in casting process in the beakers.

### Example 4

Temperature Profiles of Processes of the Invention

Pre-Heating of the Mixtures to 45° C.

The delay in the start of the polymerisation is due to the fact that the combined mixtures are at room temperature when loaded into the tube. This delay can be eliminated by preheating mixtures to the reaction temperatures before the combining step in the static mixer.

In order to be able to obtain an even more narrow distribution of the polymer network formed during the polymerization in the tube reactor system it is beneficial to let the reactive stream, composed of the two basic solutions mixed for example in a 1:1 ratio, be preheated to the desired polymerization temperature when or just before they are mixed. This will off course affect the exotherm observed in the tube reactor which will be a little bit higher compared to the experiments where the basic solutions were at room temperature when purred into the tube reactor. The temperature profile for a polymerization with a preheated A+B solution is shown below in Table 4.

| Time | Temp | Time | Temp |
|---|---|---|---|
| sec | ° C. | sec | ° C. |
| 100 | 47.82 | 100 | 46.48 |
| 200 | 48.52 | 200 | 48.61 |
| 300 | 47.59 | 300 | 47.86 |
| 400 | 46.75 | 400 | 46.93 |
| 1500 | 45.26 | 1500 | 45.23 |

### Example 5

Temperature Profiles of Processes of the Invention

Change in Materials

The present investigators have demonstrated that it is possible to reduce the exotherm from 5 to 3.5° C. by replacing the plastic tube with a tube made out of stainless steel as shown in Table 5 below. This reduction in exotherm temperature is due to a better heat transmission between the reaction media in side the tube and the surrounding water bath at 45° C.

| Time | Temp | Temp |
|---|---|---|
| Seconds | ° C. | ° C. |
| 0 | 45.06 | 45.11 |
| 100 | 46.88 | 44.82 |
| 200 | 49.72 | 46.92 |
| 300 | 49.88 | 46.44 |
| 400 | 49.07 | 46.4 |
| 500 | 48.2 | 45.83 |
| 600 | 47.38 | 46.29 |
| 700 | 46.76 | 45.51 |
| 800 | 46.33 | 45.62 |
| 900 | 46.03 | 45.53 |
| 1000 | 45.79 | 45.45 |
| 1100 | 45.64 | 45.43 |
| 1200 | 45.53 | 45.42 |
| 1300 | 45.52 | |
| 1500 | 45.41 | |
| 1700 | 45.31 | |
| 2000 | 45.24 | |
| 2500 | 45.16 | |

### Example 6

Temperature Profiles of Processes of the Invention

Preheating of the Reaction Mixtures to 55° C.

Even at this higher temperature, where it is normally more difficult to control the exotherm reaction due to a higher reaction rate, it was possible to limit the temperature rise to 5° C. in a Teflon tube of 18 mm and 8 mm.

In the 18 mm tube, the maximum temperature in the pipe reactor was 60.04° C. at 185 seconds; resulting in a temperature differential of 5° C. In the 8 mm tube, the maximum temperature in the pipe reactor was 57.26° C. at 100 seconds and at 135 seconds; resulting in a temperature differential about 2.3° C.

### Example 7

Heat Transmission from Gel Polymerizing Inside a Tube and out to the Surrunding Cooling Media

The values in the Table 6 are experimental values from the temperature profile curves of different preheated solutions casted in a Teflon tube/pipe of diameter of 8 mm (9 gram LV PAAG solution) or 16 mm (40 gram) and a steel tube of diameter of 16mm (32,15 gram); all with a length of 16 cm, i.e. with a length >>diameter. The temperature in the water bath surrounding the tube was in all three experiments at 45° C.

The area under the temperature curve for a 100 sec segment around the peak exotherm (where equilibrium is obtained) was compared to the total area under the curve until 1800 sec, and used to calculate the partial amount of heat developed for that specific segment; the temperature within the chosen segments is almost constant. It can be seen that larger tube diameter results in a higher delta-T, and that the delta-T is affected by the nature of the tube material. It is seen from the experiments that the total delta-T is diminished by using a minor tube diameter and by using a stainless steel tube in stead of a Teflon tube. It is of course possible to use Teflon coated stainless steel tubes also.

TABLE 6

| | | | | | tube | | Delta- |
|---|---|---|---|---|---|---|---|
| T1 | T2 | delta-T | peak-T | delta-T | diameter | tube | heat |
| (sec) | (sec) | (sec) | (° C.) | (° C.) | (mm) | material | (J/sec) |
| 150 | 250 | 100 | 46.8 | 2.0 | 8 | teflon | 0.8 |
| 200 | 300 | 100 | 50.0 | 5.0 | 18 | teflon | 3.8 |
| 150 | 250 | 100 | 48.5 | 3.5 | 16 | steel | 3.9 |

For a given amount of heat developed, the temperature in the polymerizating mass will raise until the driving force delta-T for the system will be able to transfer the heat away from inside the tube and out in the water. Theoretically the total heat transmission from the tube to the surrounding cooling media can be broken down into different segments which can be estimated one by one. The heat resistance is then composed of the following single elements:

A.) The first part is a simple heat conductivity through the gel as described in detail in A.B. Then follows a heat convection/transition from the outermost part of the gel material to the inner wall part of the tube, which is described in details in B.

C.) Next a heat conduction takes place through the wall part of the tube material until the outer surface of the tube as described in C.

D.) At last a heat transition from the outer part of the wall to the cooling media, which is not cirtical in our set-up/calculation as it is the part givning almost no contribution to the heat resistance (only a little delta-T necessary here) when a turbulent flow of the cooling media is applied.

This heat transition D. is left out in the discussions below.

A Transmission of Polymerisation Heat from the Gel Inside the Tube and to the Inner Surface Wall

The transmission of polymerization heat to the insider of the tube can be calculated from the equation 8.11 from the book “Enhedsoperationer i den kemiske industri”, 216-222, L. Alfred Hansen, (1996).

Q/tau=k*2*pi*((r2-r1)/(ln r2/r1))*L* ((t1-t2)/(r2-r1))

wherein k=0.56 J/sec metre K (for water) and L=0.16 metres

The calculation here is based on the assumption that ¼ of the total amount of polymerization heat is obtained within the inner ¼ part of the cross sectional area of the tube. In addition, the rest of the heat shall be transported from the surrounding belt and to the beginning of the inner wall. This gives an additional contribution to the needed heat transportation within the gel but here the distance is decreasing as one is getting closer and closer to the r2. These two contribution added will roughly correspond to the assumption that ⅓ of the total amount of heat is transported from r1 to r2.

This is done to simplify the calculation more easy; a more exact expression may be obtained by using an integration technique for the total cross section area taken in to account that the polymerisation heat in fact is developped equally through out the whole cross section area. The r1 value in the equation is calculated from the ¼ of the given cross sectional area of the tube. Then ⅓ of the heat of polymerisation is then transported from r1 to the beginning of the inner wall r2.

| r2 | r1 | t1 | t2 | calc delta-heat |
|---|---|---|---|---|
| (m) | (m) | (° C.) | (° C.) | (J/sec ° C.) |
| 0.0040 | 0.0020 | 1.0 | 0.8 | 0.8 |
| 0.0090 | 0.0045 | 1.0 | 0.0 | 0.8 |
| 0.0080 | 0.0040 | 1.0 | 0.0 | 0.8 |

B. Heat transition from Gel to Wall

The total amount of polymerization heat is transferred from the gel to the wall. the calculation is based on L. Alfred Hansen; “Enhedsoperationer i den kemiske industri”, 1996, p. 222. The equation is normally used for laminar flowing liquids, and can be used here as it is reasonable to assume that this is also the condition that exist for the transition from gel to the wall at very low velocities, e.g. for the 85 J/sec m2° C.; higher velocities will result in a higher heat transition values and thereby lower the resistance and delta-T in this part of the system (e.g. in a continuous system). The figures for different calculations with different tube diameters as well as velocities of the gel movement inside the tube were calculated in a similar fashion as above.

C. Conduction of Heat Through the Wall Part

The total amount of heat is conducted through the wall part. This can be calculated per degree celcius by using the equation from A and with the heat coefficient value K for teflon, which is 0.25105 J/sec m K, and a wall thickness of 1.5 mm and a delta T of one degree. The heat transmission has not been calculated for a tube made out of steel as the the heat conductivity is much larger than for water (×100).

Control of the Formula System A, B and C

It is now possible with the information from A, B and C to calculate if the observed temperature differences seems to be reasonable.

The theoretical delta-T for the system here is calculated for the 8 mm Teflon tube: From A, it is known that ⅓ of the total energy is transported by a delta heat of 0.8 J/sec° C. This correspond to a needed temperature gradient=(0.8 J/sec*⅓)/0.8 J/sec° C.=0.3° C.

From B. We know have to transfer the total enrgi of 0.8 J/sec from the gel to the wall. This “costs” an additional temperature gradient of=(0.8 J/sec/1.7 J/sec° C.)=0.5° C.

From C. Now the total amount of energy is transported through the wall and again a temperature difference is needed as the driving force=(0.8 J/sec/1.13 J/sec° C.)=0.7° C.

The total theoretically temperature difference is then the addition all the three contribution to the gradient=(0.3+0.5+0.7)° C.=1.5° C. The calculated delta-T values for the three different systems are all in very good agreement with the observed temperature difference and at the same time validate the formula set-up in A-C.

Practical Use of the Equations in the Designing of the Tube Reactor System under Different Conditions

Above are given some tools that can be used to calculate the heat and temperature distribution within the tube reactor system when designing a set-up. It is seen that geometry as well as selection of material for the tube is both important parameters when designing a continuous system. The formulas given here can be used for designing of new systems and for up-scaling of existing systems If for example a double amount of monomer is used (2×0.8 J/sec will be developed) compared to low viscosity formulations given in the first example, and it is possible to calculate the temperature of the cooling water necessary in order to obtain the same peak temperature.

### Example 8

Experimentally, the stay-time in the mixer has been determined by use of the colour method described above. The empirical stay-times is correlated with the gel point, i.e. the point at which the propagated monomer units are building up just to start the first immobilizing network and at which time it is generally accepted that the elasticity modulus G′=1 Pa. Our findings suggests that the mixture stay-time can be predetermined by having the liquid mixture exist the mixer when 0.5 Pa≦G′≦5 Pa and preferably 0.8 Pa≦G′≦2 Pa. If extending the stay-time beyond 5 Pa the forming gel at mixer exit may be difficult to move due to high resistance at last mixer elements, and the final gel performance may be compromised. If the stay-time is below 0.2 Pa, the liquid mix-up easily occurs as can be visually demonstrated by the colour method.

### Example 9

Polymer Hydrogel Hybrid Systems of More than One Polymer Type.

Hybrid A: a co-axial hybrid consisting of a surface polymer hydrogel of composition 1 and a base hydrogel polymer of composition 2;

Hybrid B: a co-axial hybrid consisting of an outer polymer hydrogel of composition 1 and a core polymer hydrogel of composition 2;

Hybrid C a multi-layer planar hybrid system consisting of a top hydrogel of composition 1, a second hydrogel layer of composition 2 directly attached to the top layer, a coating linking the two adjacent upper layers of composition 2 and the bottom hydrogel layer of composition 3.

### Example 10

Polyacrylamide Formulations for Inline Cross-Linking Process

Polyacrylamide Formulation for Making Low Viscosity PAAG

The two basic solutions, named A and B, are mixed in the static mixer

### Example 10a

| | Solution A-1:1 | | | | Solution B-1:1 | |
|---|---|---|---|---|---|---|
| | ml | moles | | | gram | moles |
| Acrylamide | 124 | 0.6978 | | AMPS | 0.53 | 0.0023 |
| 40 g/100 ml | | | | | | |
| Bis-AM 2 g/ | 11.05 | 0.0014 | | | | |
| 100 ml | | | | | | |
| TEMED | 0.42 | 0.0028 | | | | |
| vand | 364.53 | | | water | 499.5 | |
| Total ml | 500 | | | Total ml | 500 | |
| Dry matter-% | 10.10 | | | | 0.11 | |
| before wash = | | | | | | |
| Molar ratio AM/ | 486.8 | | | | | |
| BISAM = | | | | | | |
| Molar ratio | 251.3 | | | | | |
| AM + Bis-AM/ | | | | | | |
| TEMED = | | | | | | |
| Molar ratio AM + | 301.1 | | | | | |
| Bis-AM/AMPS = | | | | | | |
| Dry matter before | — | — | 5.10 | | | |
| washing, | | | | | | |
| but after mixing | | | | | | |
| in a 1:1 ratio | | | | | | |

### Example 10b

| | Solution A-5:1 | | | | Solution B-5:1 | |
|---|---|---|---|---|---|---|
| | ml | moles | | | gram | moles |
| Acrylamide | 124 | 0.6978 | | AMPS | 0.53 | 0.0023 |
| Bis-AM | 11.05 | 0.0014 | | | | |
| TEMED | 0.42 | 0.0028 | | | | |
| water | 697.88 | | | water | 166.1 | |
| Total ml | 833.35 | | | Total ml | 166.7 | |
| Dry matter-% | 6.06 | | | | 0.32 | |
| before wash = | | | | | | |
| Molar ratio AM/ | 486.8 | | | | | |
| BISAM = | | | | | | |
| Molar ratio | 251.3 | | | | | |
| AM + Bis-AM/ | | | | | | |
| TEMED = | | | | | | |
| Molar ratio AM + | 301.1 | | | | | |
| Bis-AM/AMPS = | | | | | | |
| Dry matter before | — | — | 5.10 | | | |
| washing, but after | | | | | | |
| mixing in a 5:1 | | | | | | |
| ratio | | | | | | |

The reagents were combined in ratios described in Tables 2, 3 and 4, and washed as described in the Tables (with pyrogen-free water unless indicated otherwise) to give low, medium, and high viscosity formulations. Hydrogels with solid weight contents between 0.5 and 25% polyacrylamide were prepared.

TABLE 10
Process parameters and features of resulting gel: low viscosity formulations

| | Iv1 | Iv2 | Iv3 | Iv4 | Iv5 | Iv6 | Iv7^{d} | Iv8^{e} | Iv9 | Iv10 | Iv11 | Iv11 | Iv12 |
|---|---|---|---|---|---|---|---|---|---|---|---|---|---|
| washing time | a) | 19.5 | 73.75 | 92 | 94.3 | 72.8 | 93.6 | 93.9 | 121 | 96.4 | | | |
| (hrs) | | | | | | | | | | | | | |
| dry matterⁱ | 2.55 | 2.08 | 2.63 | 2.87 | 2.89 | 3.15 | 3.68 | 3.17 | 2.18 | (5.10)^{f} | (10.2)^{f} | (10.1)^{f} | (20.2)^{f} |
| (%) | | 2.36 | 2.58 | 2.67 | 2.82 | 2.90 | 3.57 | 3.52 | | | | | |
| | | | 2.09 | | | | | | | | | | |
| molar ratio | b) | 976 | 700 | 488 | 366 | 3239 | 488 | 488 | 701 | 701 | 488 | 488 | 488 |
| AM:bisAM | | | | | | | | | | | | | |
| molar ratio | 252 | 252 | 253 | 251 | 252 | 249 | 252 | 252 | 252 | 252 | 252 | 504 | 2016 |
| AM + BISAM: | | | | | | | | | | | | | |
| TEMED | | | | | | | | | | | | | |
| molar ratio | 298 | 299 | 298 | 298 | 298 | 299 | 298 | 298 | 298 | 298 | 298 | 596 | 2385 |
| AM + BISAM: | | | | | | | | | | | | | |
| APS | | | | | | | | | | | | | |
| residual | c) | 89 | 5 | 2.97 | 2 | 5 | 1, 4 | 0.97 | 0.97 | | | | |
| monomer in | | | | | | | | | | | | | |
| ppm | | | | | | | | | | | | | |
| elasticity G′ | 0.16 | 5.23 | 14.3 | 26.6 | 57.05 | 71.7 | 39.2 | 28.5 | 28.5 | 11.1 | (911)^{g} | (1240)^{g} | (9460)^{g} |
| in Pa | | | 20.1 | | | | | | | | | | |
| viscosity | .045 | .88 | 2.35 | 4.37 | 9.1 | 11.5 | 6.29 | 4.55 | 4.55 | 1.8 | (145)^{g} | (197)^{g} | (1505)^{g} |
| in Pa s | | | 3.30 | | | | | | | | | | |
| gelation time | liquid | highly | 12 | 2 | 2 | 2 | 2.5 | 2.5 | | 3.17 | 0.00 | 1.21 | 3.5^{h} |
| (min) | | viscous | | | | | | | | | | | |
| | | liquid | | | | | | | | | | | |

a) material was liquid so washing was a dilution
b) infinite
c) since washing was not an extraction but a dilution, the residual monomer was merely decreased by the dilution factor (508 ppm to 254 ppm).
^{d}casting and washing done using 0.9% NaCl aqueous solution
^{e}casting with water; washing done using 0.9% NaCl aqueous solution
^{f}pre-wash values-washing typically reduces value by 30-55%
^{g}pre-wash values-washing typically reduces value by 20-40%
^{h}high notch sensitive
ⁱvariations in values may be due to measurement performance techniques or to location in the batch from which sample was taken

TABLE 11
Process parameters and features of resulting gel: medium viscosity
formulations

| | mv1 | mv2 | mv3 | mv4 | mv5 |
|---|---|---|---|---|---|
| washing time | 97 | 211.5 | 96 | 94.8 | 90.3 |
| (hrs) | | | | | |
| dry matter | 3.14 | 2.49 | 3.25 | 3.29 | 3.22 |
| (%) | | | | | |
| molar ratio | 310 | 310 | 290 | 289 | 289 |
| AM:bisAM | | | | | |
| molar ratio | 252 | 252 | 252 | 251 | 252 |
| AM + BISAM: | | | | | |
| TEMED | | | | | |
| molar ratio | 299 | 299 | 299 | 299 | 299 |
| AM + BISAM: | | | | | |
| APS | | | | | |
| residual | 1.6 | | 1.5 | | |
| monomer in | | | | | |
| ppm | | | | | |
| elasticity G′ | 108.5 | | 129 | 133.5 | |
| in Pa | | | | | |
| viscosity | 17.4 | | 20.6 | 21.30 | |
| in Pa s | | | | | |
| gelation time | 2.5 | 2.5 | 2.18 | | |
| (min) | | | | | |

### Example 11

Mixing with Different Ratios between the Monomer and Initiator Solutions

The experiments have until now been made with solutions of the monomer (A1) and initiator (A2) which before use are mixed in a 1:1 ratio, as shown in Example 2.

With the method of the invention, it is desirable to operate with mixing ratios of the A1 and A2 solutions that are in the range of 1:1 to 10:1. This is because it is preferably that the monomer solution is as diluted as possible in order to avoid spontaneous self-polymerisation before it reaches the tube reactor part. Moreover, the example investigates a mix of to flows of comparable volume size in order to the able to control and have the optimal function of the static mixer element.

An experiment have been made where the mixing ratios of 1:1 have been compared to 5:1. The polymerisation at 45° C. was done in a Teflon tube with a diameter of 18 mm and a total length of 17 cm; wall thickness 1.5 mm.

TABLE 11
Effect of mixing standard solutions in different proportions

| Mixing ratio | Peak temperature |
|---|---|
| Monomer: AMPS | (° C.) |
| 1:1 (std.) | 47.2 |
| 5:1 (new) | 48.8 |

The results show that the peak temperature is a little bit higher in the 5:1 ratio.

1. A process for the preparation of a substantially uniform polymer hydrogel comprising a polymerisation reaction comprising the steps of:
(i) combining a monomer component, a cross-linking component, an initiator, and optionally a promoter, or inert premixtures thereof, in a mixer;
said combining resulting in a polymerization-initiated mixture;
ii) providing said polymerization-initiated mixture through a pipe reactor such that the mixture flows in a net longitudinal direction; said providing resulting in polymer formation; wherein polymerisation reaction is a condensation or radical polymerisation;
said process comprising limiting a temperature differential between any two positions within the reactor to no more than 9° C.

2. A process according to claim 1, wherein said pipe reactor has a construction selected from the group consisting of
a) a diameter of no more than 25 mm at a monomer concentration of 1 to 6% (wt/wt) and a polymer-formation temperature of 5 to 65° C.;
b) a diameter of no more than 15 mm at a monomer concentration of 6.1 to 10% (wt/wt) and a polymer-formation temperature of 5 to 65° C.
c) a diameter of no more than 10 mm at a monomer concentration of 10.1 to 22% (wt/wt) and a polymer-formation temperature of 5 to 65° C.

3. A process according to claim 2, wherein the pipe reactor has a construction selected from the group consisting of
a) a diameter of no more than 20 mm at a monomer concentration of 1 to 6% (wt/wt) and a polymer-formation temperature of 5 to 65° C.;
b) a diameter of no more than 10 mm at a monomer concentration of 6.1 to 10% (wt/wt) and a polymer-formation temperature of 5 to 65° C.;
c) a diameter of no more than 9 mm at a monomer concentration of 10.1 to 22% (wt/wt) and a polymer-formation temperature of 5 to 65° C.

4. A process according to claim 3, wherein the pipe reactor has a construction selected from the group consisting of
a) a diameter of no more than 25 mm at a monomer concentration of 1 to 6% (wt/wt) and a polymer-formation temperature of 5 to 60° C.;
b) a diameter of no more than 15 mm at a monomer concentration of 6.1 to 10% (wt/wt) and a polymer-formation temperature of 5 to 60° C.;
c) a diameter of no more than 9 mm at a monomer concentration of 10.1 to 22% (wt/wt) and a polymer-formation temperature of 5 to 60° C.

5. A process according to any one of the preceding claims, wherein the polymerization-initiated mixture has an elasticity modulus G′ of 0.2 to 15 Pa, such as 0.3 to 10 Pa, 0.5 to 6 Pa.

6. A process according to any one of the preceding claims, wherein the polymerization-initiated mixture is a premature gel with an elasticity of 0.75 to 2.5 Pa, such as 0.8 to 2 Pa.

7. A process according to claim 1, wherein the temperature differential between any two positions within the reactor is of no more than 8° C., such as no more than 7° C., 6° C. preferably no more than 5° C., even more preferably no more than 4° C.

8. A process according to any one the preceding claims, wherein the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

9. A process according to claim 1, wherein the pipe reactor has a heat flux of 0.01 to 60 J/sec, such as 0.01 to 50 J/sec, such as 0.05 to 45 J/sec, 0.1 to 40 J/sec, 0.15 to 40 J/sec, 0.15 to 35 J/sec, 0.15 to 30 J/sec, 0.15 to 25 J/sec, 0.15 to 20 J/sec.

10. A process according to claim 9, wherein the pipe reactor has a diameter of 1 to 12 mm and a heat flux of 0.01 to 10 J/sec, such as 0.05 to 8, typically 0.1 to 8, such as 0.15 to 8 J/sec.

11. A process according to claim 8, wherein the pipe reactor has a diameter of 12.1 to 30 mm and a heat flux of 0.2 to 60 J/sec, such as 0.25 to 50 J/sec, such as 0.3 to 45 J/sec, such as 0.4 to 40 J/sec, typically 0.5 to 40 J/sec.

12. A process according to claim 1, wherein the polymer is a polymer is selected from the group consisting of polyacrylamides, polyesters, silicones, polyketones, aramides, polyimides, rayon, polyvinylpyrrolidone, polyacrylates, and polyurethanes, such as polyurethane methacrylates and co-polymers thereof.

13. A process according to claim 1, wherein the monomer component is selected from the group consisting of comprising hydroxyethyl methacrylate, hydroxyethoxyethyl methacrylate, hydroxydiethoxyethyl methacrylate, methoxyethyl methacrylate, methoxyethoxyethyl methacrylate, methoxydiethoxyethyl methacrylate, ethylene glycol dimethacrylate, polyethylene glycol methacrylate, N-vinyl-2-pyrrolidone, methyacrylic acid, acrylate, methacrylate, acrylamide and methacrylamide, vinyl alcohols, vinyl acetates, which can be optionally hydrolysed, and salts thereof.

14. A process according to claim 1, wherein the process is selected from the group consisting of a batch process and a continuous process, preferably a continuous process.

15. A process according to any one the preceding claims, wherein the polymer hydrogel is substantially uniform such that the elasticity modulus from at least two positions of the gel differ by no more than 200%, such as no more than 180%, such as no more than 170%, no more than 165%, no more than 160%, no more than 155%, no more than 150%, no more than 145%, no more than 140%, no more than 135%, no more than 130%, no more than 125%, no more than 120%, no more than 115%, no more than 110%, no more than 105%, no more than 100%, no more than 95%, no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, such as no more than 10%.

16. A process according to any one the claims the preceding claims, wherein the polymer hydrogel is substantially uniform such that the elasticity modulus from at least two positions of the gel differ by no more than 100 Pa, such as no more than 95 Pa, such as no more than 90 Pa, no more than 85 Pa, no more than 80 Pa, no more than 75 Pa, no more than 70 Pa, no more than 80 Pa, no more than 75 Pa, no more than 70 Pa, no more than 65 Pa, no more than 60 Pa, no more than 55 Pa, no more than 50 Pa, no more than 45 Pa, no more than 40 Pa, no more than 35 Pa, no more than 30 Pa, no more than 25 Pa, no more than 20 Pa, no more than 15 Pa, such as no more than 10 Pa.

17. A process according to any one of the preceding claims, wherein the polymer hydrogel is a hybrid system of more than one polymer-type.

18. A process according to claim 17, wherein the hybrid system is a multiple-polymer system of at least two polymer types, said multiple-polymer system structured in a co-axial arrangement

19. A process according to claim 17, wherein the hybrid system is a multiple-polymer system of at least two polymer types, said multiple-polymer system structured as an adjacent arrangement.

20. A process according to claim 19, wherein the hybrid system is an adjacent arrangement; wherein the polymer formation is performed at least twice so as provide a first and a further polymer-type;
such that the first and further combining or providing step for the first and further polymer-type are performed in a non-identical manner;
said process further comprising layering the first and further polymer-type to have surface area contact to the polymer-type provided by the preceding polymer formation.

21. A process according to claim 20, wherein the surface area contact is direct or mediated through a coating.

22. A process according to claim 21, wherein the coating is an adhesive.

23. A process according to claim 17, wherein at least one polymer is doped with a doping agent selected from the group consisting of an anaesthetic, an anti-septic, an anti-fungal, an antibiotics, an anti-coagulant, an adstringentic, a anti-inflammatory, an NSAID, a keratolytic agent, an epithelial growth hormone, a growth factors, a sex hormone, a cytostatic, and an anti-cancer agent.

24. A process according to claim 17, wherein at least one polymer is doped with an doping agent selected from the group consisting of a colouring agent, and a radioactive agent.

25. A process according to any one of claims 23 to 24, wherein the doping agent is pre-dispersed in the polymer forming solution and hence being imbedded in the polymer hydrogel suitable for sustaining the diffusion of the active ingredients from the the polymer hydrogel to the outer surface and hence acting as a sustained drug delivery system.

26. A process according to claim 17, wherein at least one polymer contains a conducting agent selected from the group comprising ionic polymers, dissociative metallic inorganic compounds and organic compounds.

27. A process according to claim 26, wherein the conducting agent is pre-dispersed during the combining step.

28. A process according to claim 17, wherein at least one polymer is acting as a degradable or a non-degradable tissue growth network directly or by introduction of structural additives facilitating epithelial growth in the combining step.

29. A process according to any one of the preceding claims, which is continuous process comprising a polymerisation reaction said reaction comprising the steps of
(i) combining a monomer component, a cross-linking component, and an initiator, or inert premixtures thereof;
ii) mixing the monomer component, cross-linking component, and optionally the initiator or promoter, or inert premixtures thereof until the resulting polymerization-initiated mixture is a premature gel with an elasticity module G′ of 0.75 to 2.5 Pa;
iii) providing said polymerization-initiated mixture through a pipe reactor such that the mixture flows in a net longitudinal direction; said providing resulting in the substantially uniform polymer hydrogel.

30. A process according to any one of the preceding claims, wherein at least one of the steps is under gradient pressure.

31. A process according to any one of the preceding claims, wherein the polymer hydrogel is polyacrylamide.

32. A process according to claim 31, comprising the steps of
(i) combining an acrylamide component, methylene bis-acrylamide component, and a radical initiator component, or inert premixture components thereof in a mixer said combining resulting in a polymerization-initiated mixture
ii) providing said polymerization-initiated mixture through a pipe reactor such that the mixture flows in a net longitudinal direction
said pipe reactor having a construction such that a temperature differential of no more than 9° C. is present between any two non-longitudinal positions within the reactor.

33. A process according to claim 32, wherein the combining step is performed so as to obtain a polyacrylaminde hydrogel comprises 0.5 to 25% wt/wt polyacrylamide

34. A process according to any one of claims 31 to 33, wherein the combining step comprises combining an inert premixture solution A with inert premixture solution B wherein solution A comprises acrylamide, methylene-bis-acrylamide, TEMED and optionally water; and solution B comprises AMPS and optionally water.

35. A process according to any one of claims 31 to 34, wherein the combining step comprises acrylamide and methylene-bis-acrylamide in a molar ratio of about 200:1 to 1000:1, such as about 200:1 to 900:1, such as about 200:1 to 800:1, such as about 250:1 to 800:1, such as about 250:1 such as about 300:1, 400:1, 500:1, 600:1, 700:1, and 800:1.

36. A process according to any one of claims 31 to 35, wherein said pipe reactor has a construction selected from the group consisting of
a) the pipe reactor having a diameter of no more than 25 mm at a monomer concentration of 1 to 60% (wt/wt) and a polymer-formation temperature of 5 to 65° C.;
b) the pipe reactor having a diameter of no more than 15 mm at a monomer concentration of 6.1 to 10% (wt/wt) and a polymer-formation temperature of 5 to 65° C.
c) the pipe reactor having a diameter of no more than 10 mm at a monomer concentration of 10.1 to 22% (wt/wt) and a polymer-formation temperature of 5 to 65° C.

37. A process according to any one of claims 31 to 36, wherein said pipe reactor has a construction selected from the group consisting of
a) a diameter of no more than 20 mm at a monomer concentration of 1 to 6% (wt/wt) and a polymer-formation temperature of 5 to 65° C.;
b) a diameter of no more than 10 mm at a monomer concentration of 6.1 to 10% (wt/wt) and a polymer-formation temperature of 5 to 65° C.;
c) a diameter of no more than 9 mm at a monomer concentration of 10.1 to 22% (wt/wt) and a polymer-formation temperature of 5 to 65° C.

38. A process according to any one of claims 31 to 37, wherein the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

39. A process according to any one of the preceding claims, wherein the combining step is performed at a temperature of 25 to 60° C., preferably 30 to 60° C., even more preferably 35 to 60° C., such as 40 to 60° C., 40 to 55° C., 45 to 55° C., most preferably 45 to 50° C.

40. A process according to claim 29, wherein the mixing step is performed at a temperature of 25 to 60° C., preferably 30 to 60° C., even more preferably 35 to 60° C., such as 40 to 60° C., 40 to 55° C., 45 to 55° C., most preferably 45 to 50° C.

41. A process according to claim 1, pipe reactor is made of a material selected from the group consisting of teflon, stainless steel, glass, plastic, ceramic and combinations thereof.

42. A process according to any one of the preceding claims further comprising a washing step.

43. A process according to claim 42, wherein the washing step comprises the use of a solvent wherein the monomer is soluble and wherein the hydrogel is insoluble.

44. A process according to claim 43, wherein the washing step comprises contacting the polymer with an aqueous solution.

45. A process according to claim 44, wherein the aqueous solution is selected from water, saline solution and aqueous alcohol solutions.

46. A process according to claim 44, wherein the contacting of the polymer with the aqueous solution is performed until the residual amount of monomer is less than 400 ppm, typically less than 300 ppm.

47. A process according to claim 42, wherein the washing step comprises contacting a solvent with the polymer, wherein the polymer has a specific surface area of at least 1.5 cm²/g, such as at leas 2 cm²/g, at least 3 cm²/g, at least 4 cm²/g, typically at least 5 cm²/g, at least 6 cm²/g, at least 7 cm²/g, preferably at least 8 cm²/g.

48. A process according to claim 43, wherein the washing step is performed until the level of the monomer in the polymer is below the toxicity threshold for the monomer to the human body.

49. A process according to any one of the preceding claims which is automated.

50. A method for controlling the temperature differential between any two positions within a reactor in a process for the preparation of a polymer hydrogel comprising a polymerisation reaction comprising the steps of:
(i) combining a monomer component, a cross-linking component, an initiator, and optionally a promoter, or inert premixtures thereof, in a mixer;
said combining resulting in a polymerization-initiated mixture;
ii) providing said polymerization-initiated mixture through a pipe reactor such that the mixture flows in a net longitudinal direction; said providing resulting in polymer formation; wherein polymerisation reaction is a condensation or radical polymerisation; wherein said pipe reactor having a construction selected from the group consisting of
a) the pipe reactor having a diameter of no more than 25 mm at a monomer concentration of 2 to 5% (wt/wt) and a polymer-formation temperature of 5 to 65° C.;
b) the pipe reactor having a diameter of no more than 15 mm at a monomer concentration of 6.1 to 10% (wt/wt) and a polymer-formation temperature of 5 to 65° C.;
c) the pipe reactor having a diameter 10 mm at a monomer concentration of 10.1 to 22% (wt/wt) and a polymer-formation temperature of 5 to 65° C.

51. A method according to claim 50 comprising limiting a temperature differential between any two positions within the reactor to no more than 9° C.

52. A method according to claim 50, wherein said pipe reactor has a construction selected from the group consisting of
a) a diameter of no more than 25 mm at a monomer concentration of 1 to 6% (wt/wt) and a polymer-formation temperature of 5 to 65° C.;
b) a diameter of no more than 15 mm at a monomer concentration of 6.1 to 10% (wt/wt) and a polymer-formation temperature of 5 to 65° C.
c) a diameter of no more than 10 mm at a monomer concentration of 10.1 to 22% (wt/wt) and a polymer-formation temperature of 5 to 65° C.

53. A method according to claim 52, wherein the pipe reactor has a construction selected from the group consisting of
a) a diameter of no more than 20 mm at a monomer concentration of 1 to 6% (wt/wt) and a polymer-formation temperature of 5 to 65° C.;
b) a diameter of no more than 10 mm at a monomer concentration of 6.1 to 10% (wt/wt) and a polymer-formation temperature of 5 to 65° C.;
c) a diameter of no more than 9 mm at a monomer concentration of 10.1 to 22% (wt/wt) and a polymer-formation temperature of 5 to 65° C.

54. A method according to claim 53, wherein the pipe reactor has a construction selected from the group consisting of
a) a diameter of no more than 25 mm at a monomer concentration of 2 to 5% (wt/wt) and a polymer-formation temperature of 5 to 60° C.;
b) a diameter of no more than 15 mm at a monomer concentration of 6.1 to 10% (wt/wt) and a polymer-formation temperature of 5 to 60° C.;
c) a diameter of no more than 9 mm at a monomer concentration of 10.1 to 22% (wt/wt) and a polymer-formation temperature of 5 to 60° C.

55. A method according to any one of claims 50 to 54, wherein the polymerization-initiated mixture has an elasticity modulus G′ of 0.2 to 15 Pa, such as 0.5 to 5 Pa,

56. A method according to any one of claims 50 to 55, wherein the polymerization-initiated mixture is a premature gel with an elasticity of 0.75 to 2.5 Pa, such as 0.8 to 2 Pa.

57. A method according to any one of claims 51 to 56, wherein the temperature differential between any two positions within the reactor is of no more than 8° C., such as no more than 7° C., 6° C. preferably no more than 5° C., even more preferably no more than 4° C.

58. A method according to any one of claims 51 to 57, wherein the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

59. A method according to claim 50, wherein the mixer is static mixer.

60. A method according to claim 50, wherein the pipe reactor has a heat flux of 0.0.01 to 60 J/sec, such as 0.01 to 50 J/sec, such as 0.05 to 45 J/sec, 0.1 to 40 J/sec, 0.15 to 40 J/sec, 0.15 to 35 J/sec, 0.15 to 30 J/sec, 0.15 to 25 J/sec, 0.15 to 20 J/sec.

61. A method according to claim 50, wherein the pipe reactor has a diameter of 1 to 12 mm and a heat flux of 0.01 to 10 J/sec, such as 0.05 to 8, typically 0.1 to 8, such as 0.15 to 8 J/sec

62. A method according to claim 50, wherein the pipe reactor has a diameter of 12.1 to 30 mm and a heat flux of 0.2 to 60 J/sec, such as 0.25 to 50 J/sec, such as 0.3 to 45 J/sec, such as 0.4 to 40 J/sec, typically 0.5 to 40 J/sec.

63. A method according to claim 50, pipe reactor is made of a material selected from the group consisting of teflon, stainless steel, glass, plastic, ceramic and combinations thereof.

64. A method according to claim 50, wherein the polymer is a polymer is selected from the group consisting of polyacrylamides, polyesters, silicones, polyketones, aramids, polyimides, rayon, polyvinylpyrrolidone, polyacrylates, and polyurethanes, such as polyurethane methacrylates and co-polymers thereof.

65. A method according to claim 50, wherein the monomer component is selected from the group consisting of comprising hydroxyethyl methacrylate, hydroxyethoxyethyl methacrylate, hydroxydiethoxyethyl methacrylate, methoxyethyl methacrylate, methoxyethoxyethyl methacrylate, methoxydiethoxyethyl methacrylate, ethylene glycol dimethacrylate, N-vinyl-2-pyrrolidone, methyacrylic acid, acrylate, methacrylate, acrylamide and methacrylamide, vinyl alcohols, vinyl acetates, which can be optionally hydrolysed, and salts thereof.

66. A method according to claim 50, wherein the process is selected from the group consisting of a batch process and a continuous process, preferably a continuous process.

67. A method according to any one claims 50 to 66, wherein the polymer hydrogel is substantially uniform such that the elasticity modulus from at least two positions of the gel differ by no more than 200%, such as no more than 180%, such as no more than 170%, no more than 165%, no more than 160%, no more than 155%, no more than 150%, no more than 145%, no more than 140%, no more than 135%, no more than 130%, no more than 125%, no more than 120%, no more than 115%, no more than 110%, no more than 105%, no more than 100%, no more than 95%, no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, such as no more than 10%.

68. A method according to any any one claims 50 to 66, wherein the polymer hydrogel is substantially uniform such that the elasticity modulus from at least two positions of the gel differ by no more than 100 Pa, such as no more than 95 Pa, such as no more than 90 Pa, no more than 85 Pa, no more than 80 Pa, no more than 75 Pa, no more than 70 Pa, no more than 80 Pa, no more than 75 Pa, no more than 70 Pa, no more than 65 Pa, no more than 60 Pa, no more than 55 Pa, no more than 50 Pa, no more than 45 Pa, no more than 40 Pa, no more than 35 Pa, no more than 30 Pa, no more than 25 Pa, no more than 20 Pa, no more than 15 Pa, such as no more than 10 Pa.

69. A method according to any one of claims 50 to 68, which is continuous process comprising a polymerisation reaction said reaction comprising the steps of
(i) combining a monomer component, a cross-linking component, and an initiator, or inert premixtures thereof;
ii) mixing the monomer component, cross-linking component, and optionally the initiator or promoter, or inert premixtures thereof until the resulting polymerization-initiated mixture is a premature gel with an elasticity module G′ of 0.75 to 2.5 Pa;
iii) providing said polymerization-initiated mixture through a pipe reactor such that the mixture flows in a net longitudinal direction; said providing resulting in the substantially uniform polymer hydrogel.

70. A method according to any one of claims 50 to 69, wherein at least one of the steps is under gradient pressure.

71. A method according to any one of claims 50 to 69, wherein the polymer hydrogel is polyacrylamide.

72. A method according to claim 71, comprising the steps of
(i) combining an acrylamide component, methylene bis-acrylamide component, and a radical initiator component, or inert premixture components thereof in a mixer said combining resulting in a polymerization-initiated mixture
ii) providing said polymerization-initiated mixture through a pipe reactor such that the mixture flows in a net longitudinal direction
said pipe reactor having a construction such that a temperature differential of no more than 9° C. is present between any two non-longitudinal positions within the reactor.

73. A method according to claim 72, wherein the combining step is performed so as to obtain a polyacrylaminde hydrogel comprises 0.5 to 25% wt/wt polyacrylamide.

74. A method according to any one of claims 71 to 73, wherein the combining step comprises combining an inert premixture solution A with inert premixture solution B wherein solution A comprises acrylamide, methylene-bis-acrylamide, TEMED and optionally water; and solution B comprises AMPS and optionally water.

75. A method according to any one of claims 71 to 74, wherein the combining step comprises acrylamide and methylene-bis-acrylamide in a molar ratio of about 200:1 to 1000:1, such as about 200:1 to 900:1, such as about 200:1 to 800:1, such as about 250:1 to 800:1, such as about 250:1 such as about 300:1, 400:1, 500:1, 600:1, 700:1, 800:1.

76. A method according to any one of claims 71 to 75, wherein said pipe reactor has a construction selected from the group consisting of
a) the pipe reactor having a diameter of no more than 25 mm at a monomer concentration of 1 to 6% (wt/wt) and a polymer-formation temperature of 5 to 65° C.;
b) the pipe reactor having a diameter of no more than 15 mm at a monomer concentration of 6.1 to 10% (wt/wt) and a polymer-formation temperature of 5 to 65° C.
c) the pipe reactor having a diameter of no more than 10 mm at a monomer concentration of 10.1 to 22% (wt/wt) and a polymer-formation temperature of 5 to 65° C.

77. A method according to any one of claims 71 to 76, wherein said pipe reactor has a construction selected from the group consisting of
a) a diameter of no more than 20 mm at a monomer concentration of 1 to 6% (wt/wt) and a polymer-formation temperature of 5 to 65° C.;
b) a diameter of no more than 10 mm at a monomer concentration of 6.1 to 10% (wt/wt) and a polymer-formation temperature of 5 to 65° C.;
c) a diameter of no more than 9 mm at a monomer concentration of 10.1 to 22% (wt/wt) and a polymer-formation temperature of 5 to 65° C.

78. A method according to any one of claims 71 to 77, wherein the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

79. A method according to any one of claims 71 to 77, wherein the combining step is performed at a temperature of 25 to 60° C., preferably 30 to 60° C., even more preferably 35 to 60° C., such as 40 to 60° C., 40 to 55° C., 45 to 55° C., most preferably 45 to 50° C.

80. A method according to claim 69, wherein the mixing step is performed at a temperature of 25 to 60° C., preferably 30 to 60° C., even more preferably 35 to 60° C., such as 40 to 60° C., 40 to 55° C., 45 to 55° C., most preferably 45 to 50° C.

81. A method according to any one of claims 71 to 77 which is automated.

82. A process for the preparation of a substantially uniform polymer hydrogel in a continuous process comprising a polymerisation reaction said reaction comprising the steps of
(i) combining a monomer component, a cross-linking component, and an initiator, or inert premixtures thereof;
ii) mixing the monomer component, cross-linking component, and optionally the initiator or promoter, or inert premixtures thereof until the resulting polymerization-initiated mixture is a premature gel with an elasticity module G′ of 0.75 to 2.5 Pa;
iii) providing said polymerization-initiated mixture through a pipe reactor such that the mixture flows in a net longitudinal direction; said providing resulting in the substantially uniform polymer hydrogel.

83. A process according to claim 82, wherein the premature gel has an elasticity module G′ of 0.8 to 2 Pa.

84. A process according to any one of claim 82 to 83 comprising limiting a temperature differential between any two positions within the reactor to no more than 9° C.

85. A process according to any one of claim 82 to 84, wherein the pipe reactor has a construction selected from the group consisting of
a) a diameter of no more than 25 mm at a monomer concentration of 1 to 6% (wt/wt) and polymer-formation temperature of 5 to 65° C.;
b) a diameter of no more than 15 mm at a monomer concentration of 6.1 to 10% (wt/wt) and a polymer-formation temperature of 5 to 65° C.
c) a diameter of no more than 10 mm at a monomer concentration of 10.1 to 22% (wt/wt) and a polymer-formation temperature of 5 to 65° C.

86. A process according to any one of claim 82 to 85, wherein the pipe reactor has a construction selected from the group consisting of
a) a diameter of no more than 20 mm at a monomer concentration of 1 to 6% (wt/wt) and a polymer-formation temperature of 5 to 65° C.;
b) a diameter of no more than 10 mm at a monomer concentration of 6.1 to 10% (wt/wt) and a polymer-formation temperature of 5 to 65° C.;
c) a diameter of no more than 9 mm at a monomer concentration of 10.1 to 22% (wt/wt) and a polymer-formation temperature of 5 to 65° C.

87. A process according to any one of claim 82 to 86, wherein the pipe reactor has a construction selected from the group consisting of
a) a diameter of no more than 25 mm at a monomer concentration of 1 to 6% (wt/wt) and a polymer-formation temperature of 5 to 60° C.;
b) a diameter of no more than 15 mm at a monomer concentration of 6.1 to 10% (wt/wt) and a polymer-formation temperature of 5 to 60° C.;
c) a diameter of no more than 9 mm at a monomer concentration of 10.1 to 22% (wt/wt) and a polymer-formation temperature of 5 to 60° C.

88. A process according to any one of claim 82 to 87, wherein the temperature differential between any two positions within the reactor is of no more than 8° C., such as no more than 7° C., 6° C. preferably no more than 5° C., even more preferably no more than 4° C.

89. A process according to any one of claim 82 to 88, wherein the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

90. A process according to any one of claim 82 to 93, wherein the mixer is static mixer.

91. A process according to any one of claim 82 to 90, wherein the pipe reactor has a heat flux of 0.0.01 to 60 J/sec, such as 0.01 to 50 J/sec, such as 0.05 to 45 J/sec, 0.1 to 40 J/sec, 0.15 to 40 J/sec, 0.15 to 35 J/sec, 0.15 to 30 J/sec, 0.15 to 25 J/sec, 0.15 to 20 J/sec.

93. A process according to claim 91, wherein the pipe reactor has a diameter of 1 to 12 mm and a heat flux of 0.01 to 10 J/sec, such as 0.05 to 8, typically 0.1 to 8, such as 0.15 to 8 J/sec.

94. A process according to claim 91, wherein the pipe reactor has a diameter of 12.1 to 30 mm and a heat flux of 0.2 to 60 J/sec, such as 0.25 to 50 J/sec, such as 0.3 to 45 J/sec, such as 0.4 to 40 J/sec, typically 0.5 to 40 J/sec.

95. A process according to claim 82, wherein the polymer is a polymer is selected from the group consisting of polyacrylamides, polyesters, silicones, polyketones, aramides, polyimides, rayon, polyvinylpyrrolidone, polyacrylates, and polyurethanes, such as polyurethane methacrylates and co-polymers thereof.

96. A process according to claim 82, wherein the monomer component is selected from the group consisting of comprising hydroxyethyl methacrylate, hydroxyethoxyethyl methacrylate, hydroxydiethoxyethyl methacrylate, methoxyethyl methacrylate, methoxyethoxyethyl methacrylate, methoxydiethoxyethyl methacrylate, ethylene glycol dimethacrylate, N-vinyl-2-pyrrolidone, methyacrylic acid, acrylate, methacrylate, acrylamide and methacrylamide, vinyl alcohols, vinyl acetates, which can be optionally hydrolysed, and salts thereof.

97. A process according to any one claims 82 to 96, wherein the polymer hydrogel is substantially uniform such that the elasticity modulus from at least two positions of the gel differ by no more than 200%, such as no more than 180%, such as no more than 170%, no more than 165%, no more than 160%, no more than 155%, no more than 150%, no more than 145%, no more than 140%, no more than 135%, no more than 130%, no more than 125%, no more than 120%, no more than 115%, no more than 110%, no more than 105%, no more than 100%, no more than 95%, no more than 90%, no more than 85%, no more than 80%, no more than 75%, no more than 70%, no more than 65%, no more than 60%, no more than 55%, no more than 50%, no more than 45%, no more than 40%, no more than 35%, no more than 30%, no more than 25%, no more than 20%, no more than 15%, such as no more than 10%.

98. A process according to any one claims 82 to 96, wherein the polymer hydrogel is substantially uniform such that the elasticity modulus from at least two positions of the gel differ by no more than 100 Pa, such as no more than 95 Pa, such as no more than 90 Pa, no more than 85 Pa, no more than 80 Pa, no more than 75 Pa, no more than 70 Pa, no more than 80 Pa, no more than 75 Pa, no more than 70 Pa, no more than 65 Pa, no more than 60 Pa, no more than 55 Pa, no more than 50 Pa, no more than 45 Pa, no more than 40 Pa, no more than 35 Pa, no more than 30 Pa, no more than 25 Pa, no more than 20 Pa, no more than 15 Pa, such as no more than 10 Pa.

99. A process according to any one claims 82 to 98, wherein the polymer hydrogel is a hybrid system of more than one polymer-type.

100. A process according to claim 99, wherein the hybrid system is a mulitiple-polymer system of at least two polymer types, said multiple-polymer system structured in an arrangement selected from the group comprising a co-axial arrangement and an adjacent arrangement.

101. A process according to claim 99, wherein the hybrid system is an adjacent arrangement; wherein the polymer formation is performed at least twice so as provide a first and a further polymer-type; such that the first and further combining or providing step for the first and further polymer-type are performed in a non-identical manner; said process further comprising layering the first and further polymer-type to have surface area contact to the polymer-type provided by the preceding polymer formation.

102. A process according to claim 101, wherein the surface area contact is direct or mediated through a coating.

103. A process according to claim 102, wherein the coating is an adhesive.

104. A process according to claim 99, wherein at least one polymer is doped with an doping agent selected from the group consisting an anaesthetic, an anti-septic, an anti-fungal, an antibiotics, an anti-coagulant, an adstringentic, a anti-inflammatory, an NSAID, a keratolytic agent, an epithelial growth hormone, a growth factors, a sex hormone, a cytostatic, an anti-cancer agent, a colouring agent, and a radioactive agent.

105. A process according to claim 104, wherein the doping agent is pre-dispersed in the polymer forming solution and hence being imbeded in the polymer hydrogel suitable for sustaining the diffusion of the active ingredients from the the polymer hydrogel to the outer surface and hence acting as a sustained drug delivery system.

106. A process according to claim 99, wherein at least one polymer contains a conducting agent selected from the group comprising ionic polymers, dissociative metallic inorganic compounds and organic compounds

107. A process according to claim 106, wherein the conducting agent is pre-dispersed during the combining step.

108. A process according to claim 99, wherein at least one polymer is acting as a degradable or a non-degradable tissue growth network directly or by introduction of structural additives facilitating epithelial growth in the combining step.

109. A process according to any one of claims 82 to 108, wherein at least one of the steps is under gradient pressure.

110. A process according to any one of claims 82 to 109, wherein the polymer hydrogel is polyacrylamide.

111. A process according to claim 110, comprising the steps of
i) combining an acrylamide component, methylene bis-acrylamide component, and a radical initiator component, or inert premixture components thereof in a mixer;
ii) mixing the acrylamide component, methylene bis-acrylamide component, and the radical initiator component, or inert premixture components thereof until the resulting polymerization-initiated mixture is a premature gel with an elasticity module G′ of 0.75 to 2.5 Pa;
iii) providing said polymerization-initiated mixture through a pipe reactor such that the mixture flows in a net longitudinal direction; said providing resulting in the substantially uniform polymer hydrogel.

112. A process according to claim 111, wherein the combining step is performed so as to obtain a polyacrylaminde hydrogel comprises 0.5 to 25% wt/wt polyacrylamide

113. A process according to any one of claims 111 to 112, wherein the combining step comprises combining an inert premixture solution A with inert premixture solution B wherein solution A comprises acrylamide, methylene-bis-acrylamide, TEMED and optionally water; and solution B comprises AMPS and optionally water.

114. A process according to any one of claims 111 to 113, wherein the combining step comprises acrylamide and methylene-bis-acrylamide in a molar ratio of about 200:1 to 1000:1, such as about 200:1 to 900:1, such as about 200:1 to 800:1, such as about 250:1 to 800:1, such as about 250:1 such as about 300:1, 400:1, 500:1, 600:1, 700:1, 800:1.

115. A process according to any one of claims 111 to 114, wherein said pipe reactor has a construction selected from the group consisting of
a) a diameter of no more than 25 mm at a monomer concentration of 1 to 6% (wt/wt) and a polymer-formation temperature of 5 to 65° C.;
b) a diameter of no more than 15 mm at a monomer concentration of 6.1 to 10% (wt/wt) and a polymer-formation temperature of 5 to 65° C.; and
c) a diameter of no more than 10 mm at a monomer concentration of 10.1 to 22% (wt/wt) and a polymer-formation temperature of 5 to 65° C.

116. A process according to any one of claims 111 to 115, wherein said pipe reactor has a construction selected from the group consisting of
a) a diameter of no more than 20 mm at a monomer concentration of 1 to 6% (wt/wt) and a polymer-formation temperature of 5 to 65° C.;
b) a diameter of no more than 10 mm at a monomer concentration of 6.1 to 10% (wt/wt) and a polymer-formation temperature of 5 to 65° C.;
c) a diameter of no more than 9 mm at a monomer concentration of 10.1 to 22% (wt/wt) and a polymer-formation temperature of 5 to 65° C.

117. A process according to any one of claims 111 to 116, wherein the polymer-formation temperature is 20 to 65° C., more typically 25 to 60° C., preferably 30 to 60° C., even more preferably 35 to 60° C., such as 40 to 60° C., 40 to 55° C., 45 to 55° C., most preferably 45 to 50° C.

118. A process according to any one of claims 111 to 117, wherein the combining step is performed at a temperature of 25 to 60° C., preferably 30 to 60° C., even more preferably 35 to 60° C., such as 40 to 60° C., 40 to 55° C., 45 to 55°0 C., most preferably 45 to 50° C.

119. A process according to claim 111, wherein the mixing step is performed at a temperature of 25 to 60° C., preferably 30 to 60° C., even more preferably 35 to 60° C., such as 40 to 60° C., 40 to 55° C., 45 to 55° C., most preferably 45 to 50° C.

120. A process according to claim 82, pipe reactor is made of a material selected from the group consisting of teflon, stainless steel, glass, plastic, ceramic and combinations thereof.

121. A process according to any one of claims 82 to 120 further comprising a washing step.

122. A process according to claim 121, wherein the washing step comprises the use of a solvent wherein the monomer is soluble and wherein the hydrogel is insoluble.

123. A process according to claim 121, wherein the washing step comprises contacting the polymer with an aqueous solution.

124. A process according to claim 123, wherein the aqueous solution is selected from water, saline solution and aqueous alcohol solutions.

125. A process according to claim 123, wherein the contacting of the polymer with the aqueous solution is performed until the residual amount of monomer is less than 400 ppm, typically less than 300 ppm.

126. A process according to claim 121, wherein the washing step comprises contacting a solvent with the polymer, wherein the polymer has a specific surface area of at least 1.5 cm²/g, such as at leas 2 cm²/g, at least 3 cm²/g, at least 4 cm²/g, typically at least 5 cm²/g, at least 6 cm ²/g, at least 7 cm²/g, preferably at least 8 cm²/g.

127. A process according to claim 121, wherein the washing step is performed until the level of the monomer in the polymer is below the toxicity threshold for the monomer to the human body.

128. A process according to any one of claims 82 to 127 which is automated.

129. A method for preparing a biocompatible polymer hydrogel comprising the steps of providing a hydrogel so as to have a specific surface area of at least 1.5 cm²/g and contacting said hydrogel with an aqueous medium until the polymer comprises an amount of monomer below the toxicity threshold for said monomer to the human body.

130. A process according to claim 129, wherein the washing step comprises the use of a solvent wherein the monomer is soluble and wherein the hydrogel is insoluble.

131. A process according to claim 129, wherein the washing step comprises contacting the polymer with an aqueous solution.

132. A process according to claim 131, wherein the aqueous solution is selected from water, saline solution and aqueous alcohol solutions.

133. A process according to claim 131, wherein the contacting of the polymer with aqueous solution is performed until the residual amount of monomer is less than 400 ppm, typically less than 300 ppm.

134. A process according to claim 129, wherein the washing step comprises contacting a solvent with the polymer, wherein the polymer has a specific surface area of at least 2 cm²/g, at least 3 cm²/g, at least 4 cm²/g, typically at least 5 cm²/g, at least 6 cm²/g, at least/cm²/g, preferably at least 8 cm²/g.

135. A process according to claim 129, wherein the aqueous medium is selected from the group consisting of water, isotonic solutions and alcohol solutions.

136. A method of removing monomeric units from a polymer hydrogel comprising providing the polymer hydrogel so as to have a specific surface area of at least 1.5 cm²/g; washing the polymer hydrogel such that the level of monomeric unit in the hydrogel is less than 400 ppm with an aqueous medium.

137. A method of swelling a polymer hydrogel comprising providing the polymer hydrogel so as to have a specific surface area of at least 1.5 cm²/g; contacting the polymer hydrogel with an aqueous medium until the desired solid-weight content is obtained.

138. The method according to claim 137 wherein the desired solid-weight content is 1 to 20%.

139. A substantially uniform polyacrylamide hydrogel obtainable according to a process defined in any one of claims 1-49, or 82-135.

140. A substantially uniform polyacrylamide hydrogel obtainable according to a method defined in any one of claims 50-81.

141. A process for the preparation of a polyacrylamide hydrogel comprising
i) combining an acrylamide component, methylene bis-acrylamide component, and a radical initiator component, or inert premixture components thereof;
ii) mixing the acrylamide component, methylene bis-acrylamide component, and the radical initiator component, or inert premixture components thereof until the formation of the polyacrylamide hydrogel;
iii) contacting a the polyacrylamide hydrogel with a solvent which is miscible with water and which is soluble to the acrylamide component or methylene bis-acrylamide and which is not a solvent for the polymer, said solvent provided in excess so as to extract the water from the hydrogel as well as the acrylamide component or methylene bis-acrylamide until a white solid polymer is precipitated.

142. A process according to claim 141, wherein the solvent is selected from methanol, ethanol, propanol, butanol and derivatives thereof.

143. A process according to claim 142, wherein the solvent is selected from ethanol, propanol and butanol, preferably ethanol.

145. A process according to claim 143, wherein the solvent is ethanol and provided in an excess so as to be in about 10-fold to 100-fold excess with respect to the amount of water.

146. A process according to claim 141, further comprising separating the precipitated white, solid polymer from the solvent mixture by centrifugation or by a filtration operation.

147. A process according to claim 146, wherein the polymer is dried in a vacuum oven to remove excess solvent.

148. A process according to claim 147, wherein the dried polymer is rehydrated with an aqueous medium to a desired solid content level.

149. A polyacrylamide hydrogel obtained by a process defined in any one of claims 141 to 148.
